(19) United States
(12) Patent Application Publication
(10) Pub. No.: US 2013/0130272 A1
(43) Pub. Date: May 23, 2013

(54) METHOD, REAGENT, AND APPARATUS FOR DETECTING A CHEMICAL CHELATOR

(71) Applicants: Harmesh Singh Aojula, Oldham (GB); David John Clarke, Cheshire (GB)

(72) Inventors: Harmesh Singh Aojula, Oldham (GB); David John Clarke, Cheshire (GB)

(73) Assignee: Advanced Biomedical Limited, Oldham (GB)

(21) Appl. No.: 13/261,577

(22) PCT Filed: Jul. 29, 2011
(86) PCT No.: PCT/GB2011/001147

§ 371 Date: Jan. 29, 2013

(30) Foreign Application Priority Data
Jul. 31, 2010 (GB) 1012875.9
Oct. 29, 2010 (GB) 1018321.8

(51) Int. Cl. G01N 21/76

(52) U.S. Cl. CPC G01N 21/763
USPC 435/7.1

(57) ABSTRACT

A method for detecting a first chelator (shown in the figure as dipicolinic acid DPA (1), the method comprising the steps of providing a reagent (2) comprising a second chelator (shown as a luminescent dye (3) and a metal ion (4), contacting the reagent (2) with a sample (6) containing the DPA (1), exciting a luminescence (7) of the dye (3), and detecting the luminescence (7) emitted by the dye (3), the method being characterized in that the metal ion (4) is bound to the luminescent dye (3) within the reagent (2), the luminescence (7) of the dye (3) is altered by the metal ion (4), the metal ion (4) is capable of binding to the DPA (1), and the dye (3) and the metal ion (4) are such that the DPA (1) can compete for the metal ion (4) in competition with the dye (3), thereby re-establishing the luminescence (7) of the dye (3).

### FIELD OF INVENTION

The invention relates to a method, reagent, and apparatus for detecting a chemical chelator and in particular dipicolinic acid (DPA). The invention has application in the detection or treatment of microbes including spores for medical, clinical, food hygiene, and military applications. Spores obtainable using the method form a further aspect of the invention.

### BACKGROUND TO THE INVENTION

Monitoring of pathogens is becoming increasingly important to control infection both in clinical and community settings. Rapid tests are needed to ensure food, water and environment safety. Given the large number of pathogens which pose health risks it is expensive to monitor risk from every pathogen using a highly specific test. Thus non-specific monitoring of microbial contamination is now employed in hygiene monitoring. Conventional laboratory based techniques requiring culturing of microorganisms are accurate but are not rapid or sufficiently cost-effective to be used regularly outside the laboratory. Such tests as colony counting and the polymerase chain reaction (PCR) are thus not suited for general use to monitor hygiene. Advances are being made in these fields; for instance the real-time-PCR method has been speeded up considerably but still requires several hours. As the growth of microorganisms can take many hours to form colonies, people have turned, in pursuit of speed, to detect microbial residues. Several such tests are available including agglutination kits to detect microbial markers such as toxins. These tests are however relatively insensitive and costly. One of the few exceptions to these tests is the adenosine triphosphate (ATP) test which is rapid and has high sensitivity. The ATP test however has a number of limitations. Its specificity is almost zero as ATP is abundant in all animal, vegetable, bacteria, yeast and mould cells. A measure of ATP is taken as measure of total organic load which is not always representative of total microbial load. Some microbes such as endospores have undetectable or very low ATP levels, and yet they can be a prime source of infection.

Living bacteria are referred to as vegetative cells. Vegetative cells can be killed by subjecting the cells to harsh conditions. However some bacterial cells, such as members of genera Bacillus, Clostridium and Sporosarcina, have the ability to form endospores under such conditions. Endospores are a metabolically dormant form of bacteria that can be present in high numbers when bacteria encounter inhospitable conditions such as lack of nutrients. The spores can remain in this resilient state for a long time, sometimes lasting years, until favourable conditions allow germination. The structure of the spore is such that they have a core structure protected by layers of a tough coating that makes them highly resistant to physical or chemical damage. The ATP assay with its above said disadvantages is incapable of detecting spores.

Specific methods of detecting spores include the use of immunoassays for detecting surface antigens. Immunomagnetic particles have also been reported [Appl Environ Microbiol. 1996 September; 62(9): 3474-3476] to be able to capture spores.

Dipicolinic acid (DPA) is known to be present in endospores, but is not present in fungal spores, viruses, or pollen. It is a major constituent of bacterial endospores (−10%, dry weight) and is present in all endospores. As a result, it has been used as a marker to detect bacteria spore content providing an estimate of total spore numbers. Inside the spores it is present as a chelate, notably with calcium ions. When spores germinate, DPA and calcium ions are released while water enters the spore to allow rehydration of the core. The released DPA can be detected by number of techniques the most common of which involves the principle of forming a chelate with terbium and recording the luminescence of the DPA-Tb³⁺ chelate. Other approaches [Appl Environ Microbiol, October 2006, p. 6808-6814, Journal of the American Chemical Society 2006 128 (39), 12618-12619] have also been used to measure released DPA including ultra violet light absorption, Fourier transform infra-red spectroscopy (FT-IR), fluorescence life-time measurements, iron(II)-DPA colourimetry, and Raman spectroscopy. Patent application US2008/0093566 describes a method for detecting spores with ultra-violet radiation, non-destructively and without any added dyes. Patent application WO03/065009 used the standard terbium assay to detect spores using an ultra violet light source and by measuring fluorescence lifetimes of the terbium. Patent application U.S. Pat. No. 5,876,960 describes the use of terbium ions to measure spores by measuring the luminescence of the terbium after chelation with DPA. In the above aforementioned methods, the spores are subjected to harsh treatments, such as heating, in order to break the coatings and release the DPA. In order to provide sufficient signal, it is necessary to release DPA from at least a million spores. This is a disadvantage because the presence of a small number of spores can be infectious.

Various fluorescent indicators are available to detect many physiologically important molecules inside cells. Examples include fluorescence probes that can bind to nucleic acids, calcium, magnesium, sodium, protons, enzymes, peptides and proteins. Bacterial spores can be weakly stained with dyes that bind to nucleic acids. These include DAPI and acridine orange, as well as membrane staining dyes such as di-4-ANEPPS, and a dye that binds to anionic phospholipids, 10-N-nonyl acridine orange [J Appl Microbiol. 2009 March; 106(3): 814-824]. Fluorescence dyes for measurement of calcium [Analytica Chimica Acta 435 (2001) 239-246] from bacterial endospore suspensions have also been described. However, because markers such as calcium, nucleic acids and phospholipids are naturally abundant, they are not specific indicators of spore presence. Calcium in particular is not only found in most life forms, but is also frequently present (for example in hard water) making calcium a poor marker for detecting spores.

The terbium DPA assay relies on an intermolecular energy transfer to cause a fluorescence change. This mechanism is not highly efficient due to non-radiative decay. Only a small part of the excited energy from DPA is transferred to the terbium ions, resulting in a relatively weak luminescence. To increase the relative luminescence (that is to improve the quantum efficiency), various other ligands have been attached to enhance the lanthanide fluorescence (Journal of Alloys and Compounds Volume 334, Issues 1-2, 28 Feb. 2002, Pages 228-231 and references therein). A neutral ligand like trioctyl phosphine oxide has been used as a secondary ligand to obtain a better quantum yield, but with limited success. Ligands that can shield the lanthanide complex have reduced the probability of non-radiative decay, but nevertheless the quantum yield of the complex is far from the quantum efficiencies one observes with commonly used fluorescent stains such as calcein [Halverson, J. Brinen and J. Leto J. Chem. Phys. 41 (1964), p. 157, 2752.]. None of these chemical modifications are likely to solve the problems of detecting native DPA in spores. Therefore while the DPA-Tb³⁺ assay [Reviewed in Analytical Chemistry 18(1-2), 1-21, 1999. Analyst 124(11), 1599-1604, 1999] is useful to detect the released DPA from spore suspensions, it has many shortfalls. The molar absorbtivities and quantum yields of DPA-metal chelates are poor. Such complexes do not yield as bright a fluorescence signal when compared to fluorescent dyes that are commonly used in high sensitivity assays.

Another limitation of the standard DPA-Tb³⁺ assay for detecting spores is that it generally requires the DPA to be released from spores into solution which is then measured to record luminescence. The DPA is diluted from a high concentration inside the spore to almost undetectable levels when suspended in large volume. Since endospores are only a fraction of the size of a bacteria, it would be advantageous if it were possible to detect the DPA sequestered in a small microscopic compartment within the spore without having to first release the DPA into solution. Microscopic detection of spores, without release of DPA, would thus provide huge signal amplification over existing methods. To highlight this further it is estimated that there can be 10⁸ DPA molecules per spore on average. The content of the DPA is relatively high inside a single spore (molar concentration in the 0.5 mM range or higher). The release of the DPA into a 1 mL volume of solution causes a signal dilution of 5×10⁹ fold. A single spore releasing its DPA content into a 1 mL solution provides a concentration of 10⁻¹³ M which is millions of orders of magnitude below the micromolar detection limit of DPA-Tb³⁺. Thus the terbium assay is not sensitive in practice, and requires a high number of spores to produce a detectable signal.

Another limitation of the DPA-Tb³⁺ assay is that the complex requires excitation energy by ultra-violet light, typically at 276 nm. This brings a number of problems when considering biological samples and the matrices they may be present in, since most such samples will themselves have ultra-violet absorption properties. In addition to this, microscopic applications of this assay are severely limited as ultra-violet light sources for microscopic imaging are expensive and pose health risks to the observer.

Many fluorescent dyes are being used in fluorescence microscopy or fluorescence cytometry or other flow through devices to label objects and allow detection. In some cases the dyes are merely used as straight tags or labels. In other cases the dye can bind to certain part of the object and provide a site specific signal. In any case there can be a background signal from the non-specific binding of dye which needs to be kept minimum for signal resolution. Thus additional steps such as washing, use of a flow system, and spreading the objects over larger areas are useful means to reduce background. Cytochemical fluorescent dyes as well as dyes conjugated to biomolecules (fluorescence probes) can selectively label certain cell compartments and there are hundreds [Microscopic techniques in Biotechnology, Michael Hoppert ISBN: 9783527301980] of such dyes available for microscopic and other cytometry applications. Some of the dyes with high quantum yields include Calcein and its derivatives, Fluorescein and its derivatives, teramethylrhodamine, texas red, Alexa fluor, DyLight, Cy3 and Cy5. Quantum dots and near infra red dyes are also emerging as useful labels with additional benefits. While such dyes can provide much more sensitive and highly stable signals, they have not found any use in direct detection of DPA in spores as they have do not have the ability to bind DPA specifically.

Dyes have been used to detect spores by detecting the presence of calcium, nucleic acids, and phopholipids. For example, fluorescent dyes such as calcein [Analytica Chimica Acta 435 (2001) 239-246] have been used. However, calcium being very prevalent in biological samples is not a specific marker of spores. Furthermore, calcein has not been used to penetrate into spores, or detect single spores. Calcein is neither a sensitive nor a specific probe for calcium detection as it has a large background signal in the absence of calcium, responds non-specifically to other metal ions including Al, Ba, Ca, Cu, Mg and Zn and is reported to be sensitive to calcium in alkaline solutions only. The reason for the pH sensitivity is clear from the work of Wallach and Steck in 1963 [Anal. Chem. 35:1035] showing that large increases in fluorescence could be measured upon complexation of calcein to calcium at pH 12 whereas only small (<12%) changes in fluorescence could be produced by complexation at neutral pH. Such studies have documented that calcein as an indicator of calcium would thus seem to be sensitive only under highly alkaline conditions. The measurement thus provides very poor contrast between fluorescence emitted from calcein bound to the calcium from a spore and background fluorescence emerging from the calcein in solution. The method is also non-specific as it is unable to detect DPA as calcein is not able to respond to DPA.

Metal ions, such as terbium, have been used to bind with DPA. In such prior art cases the DPA is released from the spores by physical (heat, microwave, sonication), chemical (dodecylamine) or biochemical (germinating spores with L-alanine) means [Analytica Chimica Acta 455 (2002) 167-177] contacted with the terbium ions, and the presence of the DPA is then detected from the luminescence of the terbium DPA complex. However, the resulting luminescent signal, that occurs by energy transfer from DPA to terbium, is weak, is not localized within the spore, requires UV excitation, and is not able to detect single spores.

An aim of the present invention is to provide a method, reagent and apparatus for detecting a chemical chelator which reduces the above aforementioned problems.

### THE INVENTION

According to the invention, there is provided a method for detecting a first chemical chelator, the method comprising the steps of contacting a reagent comprising a second chelator bound to a metal ion, with a sample containing or suspected of containing the first chemical chelator, wherein at least one of the second chelator and the metal ion is luminescent, the metal ion is capable of binding to the first chemical chelator in competition with the binding to the second chelator so that contact with the reagent changes the luminescence of the sample, exciting a luminescence of at least one of the second chelator and the metal ion and detecting the luminescence emitted by the sample.

The reagent may be such that it can penetrate into a spore. The spore may be a bacterial endospore. The spore may be a viable non-germinating spore. This is an important aspect of the invention because it enables luminescent reagents to be targeted at specific chemical markers within spores.

By detecting luminescence from the sample and in particular any changes in luminescence as a result of contact of the reagent with the sample, and the resultant transfer of the metal ion to the first chemical chelator which transfers releases the second chelator from the metal ion, the presence of the first chemical chelator can be determined. This may be useful in homogenous assays for the detection of chemical chelators for example where these are free in a liquid sample; as well as in staining procedures where structures such as biological structures containing the chemical chelator may be visualised as a result.

In some embodiments, the method may be used to quantitate the amount of the first chemical chelator present, for instance, by measuring the degree of change in luminescence of one or both of the second chelator and the metal ion before and after the metal ion associates with the first chemical chelator, and relating this to a dose-response curve as exemplified below.

The second chelator may be a dye. The reagent may comprise a dye-metal complex.

In particular, the first chemical chelator is dipicolinic acid as is found in spores, but the technique may be applied to the detection of any chemical chelator where suitable metal ions/dyes combinations can be identified. Suitable chelators may be those that have high binding affinity to lanthanides. Such chelates include polyamino carboxylic acids such as ethylenediaminetetraacetic acid (EDTA), dipicolinic acid, diaminopimelic acid (DAP), n-acetlymuramic acid, sulfolactic acid, and phosphoglyceric acid. Suitable identification techniques are exemplified hereinafter.

The sample may contain or may be suspected of containing at least one spore comprising dipicolinic acid.

The spore may be a bacterial endospore. The spore may be a viable non-germinating spore.

The spore may comprise an exosporium or spore coat, and the reagent may be able to cross the exosporium or spore coat. The spore may comprise a cortex, and the reagent may be able to cross the cortex.

The method may include the step of releasing the dipicolinic acid from the spore into solution.

The first chemical chelator may be present in the form of a chelate (such as calcium dipicolinate).

Luminescence from either the second chelator or the metal ion or both may be excited and detected in the method of the invention. In the case of the second chelator, this will change if it is released from the metal ion as a result of the presence of the first chemical chelator. In the case of a luminescent metal ion, this will change depending upon whether it is associated with the first chemical chelator or the second chelator. These changes can be detected.

In particular the second chelator is a dye, in particular a luminescent dye such as a fluorescent dye, so as to allow for a clear luminescent signal. The effect of the metal ion on the luminescence of the second chelator will result either in quenching or enhancement of the luminescent signal whereupon competitive binding of the metal ion to the chelator will cause dequenching or quenching respectively. In most cases, the metal ion will quench the luminesence of the dye and thus competitive binding of the metal ion to the chemical chelator will result in dequenching of the luminescence of the dye. Thus, according to a nonlimiting embodiment of the invention, there is provided a method for detecting DPA, the method comprising the steps of providing a reagent comprising a luminescent dye and a metal ion, contacting the reagent with a sample containing the DPA, exciting a luminescence of the dye, and detecting the luminescence emitted by the dye, the method being characterized in that the metal ion is bound to the luminescent dye within the reagent, the luminescence of the dye is quenched by the metal ion, the metal ion is capable of binding to the DPA, and the dye and the metal ion are such that the DPA can compete for the metal ion in competition with the dye, thereby dequenching the luminescence of the dye.

In particular, where the first chemical chelator is DPA, the method of the invention can be used to detect the presence of spores or visualise spores that are present. Thus the sample will be a sample containing or suspected of containing spores.

If necessary, the spores may be disrupted as a preliminary step in order to release DPA into the sample as described previously. However, the applicants have found that this is usually unnecessary as the reagent comprising the dye and the metal ion penetrates the envelope of many bacterial spores and so can be used to stain spores. Thus in a particular embodiment, preliminary disruption of the spores is unnecessary. This is a surprising discovery given the aforementioned difficulties of staining spores. Furthermore, by causing a dye to be released upon contact with the DPA, the method of the present invention can be used to reduce the background fluorescence and thereby solves the poor contrast problems of simply detecting calcium with dyes. It also solves the weak signal problems associated with the use of luminescence from a metal ion. It also allows the luminescence of the dye to be detected together with the luminescence from the metal ion, providing yet further selectivity. Samarium, europium, terbium and dysprosium ions can be used to detect many chelates, including DPA, where energy transfer from the chelates to the rare-earth ion provides strong luminescent signal amplification. The luminescent signal can be measured using time gated detection in order to reduce interference from background fluorescent signals which decay far more rapidly than the luminescent signal. Therefore luminescent signal may be measured as fluorescence life-time. The luminescent signal may also be measured as shift in wavelength of emission or excitation.

Importantly, by causing a dye to be released upon contact with the DPA, it allows a compartment (such as the core or the cortex of the spore) that is rich in DPA to be preferentially stained. The invention also allows a stained spore compartment to be imaged with an imaging system such as a microscope. The ability to preferentially stain a DPA rich compartment within the spore is believed to have important implications for researching and exploiting the microbiology of spores. In particular, it can be used to provide selective treatment for bacterial endospores since if the spore can be stained, it can be made photosensitive, and thus can be germinated or destroyed by illuminating with light.

DPA is an effective chelator of lanthanides and other metal ions, is more effective than other chelators that may be present in the cell wall of vegetative cells including the mother cell that forms the endospore, and in viable spores is present in much higher concentrations. Accordingly, higher staining of spores is observed than the staining of the mother cell, or other cells that will be present in the sample. This is important because it allows specific detection of bacterial endospores compared to vegetative bacterial cells, fungal spores, pollen, and viruses, none of which contain DPA.

It is known that when spores germinate, the spore coat and the inner membranes become more permeable, such that high levels of DPA is released from the core through the core cell inner membrane and through the cortex over a period of hours. During this time the germinating spore can be stained, and the stain would penetrate more deeply into the spore, including into the core. After a period of hours, once some or all of the DPA has leached away, the spores do not stain as brightly as prior to leaching, and may not stain at all. Thus the method provides for the detection of intact viable and non-viable spores, as well as germinating or germinated spores.

The present invention is distinguished from the prior art as it allows detection of DPA. It also does not rely on the luminescence properties of lanthanide ions that require an ultra violet excitation source. To our knowledge no DPA specific fluorescence stains have been developed to detect DPA in spores, either with a resolution capable of detecting single spores, or using excitation wavelengths longer than ultra violet light.

The sample will generally comprise a sample that is known or is suspected of containing spores. The method of the invention may be used to detect DPA in samples that comprise at least one spore.

The second chelator such as the dye and the metal ion may be bound together by any type of chemical bonding provided only that the DPA will be able to compete with said binding. Thus they may be bound together by strong bonds such as ionic or covalent bonding, but in a particular embodiment will be bound together by weak bonds such as dipole-dipole interaction, hydrogen bonding, or van der Waals forces including London dispersion forces (LDF). In a particular embodiment, the dye and the metal ion form a dye-metal complex.

In particular the reagent comprising the second chelator and the metal ion is obtained by mixing the second chelator with the metal ion which may be in form of a salt or a hydrate of the salt. Suitable metal salts may include halide salts such as a chloride, fluoride or bromide, or a sulphate, phosphate or carbonate salt. In particular, the salt is a chloride salt or a hydrate thereof.

Suitably the metal salt and the second chelatore such as the dye are mixed together in solution in a solvent such as water or an organic solvent. In particular, the solution is an aqueous solution. The ratio of metal salt to second chelator will be determined by the nature of the complex required, but will generally be in the range of from 20:1 to 1:20, and suitably from 5:1 to 1:5, and in an embodiment from 5:1 to 1:1.

As mentioned above, in a particular embodiment, the reagent such as the dye metal complex may be such that it is able to permeate into the spore. The spore may comprise a spore coat, and the dye-metal complex may be such that it is able to cross the spore coat. The spore may comprise an exosporium, and the dye-metal complex may be such that it is able to cross the exosporium. Where the spore comprises a barrier layer such as an exosporium or spore coat, the reagent comprising the dye-metal complex is such that it is able to cross the barrier.

In a particular embodiment, the invention provides a method for detecting at least one spore comprising a spore coat, which method includes the steps of providing a quenched luminescent dye-metal complex, which complex comprises a luminescent dye and a metal ion, causing the dye-metal complex to cross the spore coat, exciting the luminescent dye with a light source to emit a luminescent signal, and detecting the luminescent signal with a detector.

Once the reagent has permeated into the spore, it can be visualised by the presence of the free dye, that is, when the dye is dissociated from the metal ion. Spores comprising a dye obtainable using the method of the present invention may themselves be useful as a research tool in investigations into spore development and viability, and also as biological indicators in other assays or testing methods and as such, these form a further aspect of the invention.

The spore may comprise the DPA. The method may include the step of releasing the DPA from the spore into solution.

The method may be for detecting at least one spore containing DPA, which method includes the steps of providing a reagent as described above and in particular a quenched luminescent dye-metal complex, which complex comprises a luminescent dye and a metal ion, releasing the DPA from the at least one spore, contacting the reagent such as the quenched luminescent dye metal complex with the DPA, exciting the luminescent dye with a light source to emit a luminescent signal, and detecting the luminescent signal with a detector.

The luminescence of the reagent will change when in contact with the DPA. In particular, the quenched luminescent dye metal-complex may become dequenched when in contact with the DPA.

The method may be for detecting at least one spore comprising an exosporium, which method includes the steps of providing a quenched luminescent dye-metal complex, which complex comprises a luminescent dye and a metal ion, causing the dye-metal complex to cross the exosporium, exciting the luminescent dye with a light source to emit a luminescent signal, and detecting the luminescent signal with a detector.

In the preceding methods, the metal ion and the second chelator such as a dye may be selected such that the luminescence of the second chelator is quenched more strongly by the metal ion than by calcium ions on a molar basis.

The second chelator may be a luminescent dye. The luminescent dye may be selected from the group comprising at least one of Xanthene, cyanine, coumarin, napthalenes, pyrenes, oxadiazole, oxazine, Acridine, tetrapyrrole, as well as others such as Alexa fluor, DyLight, Cy3, Cy5, Quantum dots and near Infra-Red dyes, derivatives thereof, and charge transfer complexes such as exciplexes, or may be a fluorescent dye. The fluorescent dye may be calcein.

The fluorescent dye may be selected from the group comprising the following and their derivates: Calcein, resorufin, Fluorescein, rhodamine, texas red, Alexa fluor, DyLight, Cy3 and Cy5, Quantum dots, and near infra red dyes, and fura dyes. The fluorescent dye may be calcein.

The metal ion may be monovalent or multivalent. In a particular embodiment the metal ion is multivalent.

The metal ion may be selected from a group comprising a rare earth metal, an actinide, a transition metal, indium, tin, thallium, lead, and a bismuth ion. The metal ion may be a samarium, europium, terbium or dysprosium ion.

The metal ion may be selected such that when it binds to the first chelator (for example DPA) it forms a first chelate which chelate has a higher luminescence than the metal ion and when it binds to the luminescent dye it forms a second chelate which chelate has lower (quenched) luminescence than the luminescent dye.

The metal ion may be selected such that the association constant of the first chelator to the metal ion is at least ten times higher than the association constant of the first chelator to a calcium ion. The association constant may be at least one hundred times higher. The association constant may be at least one thousand times higher.

The sample may comprise a plurality of the spores in a solution, and the method may include the step of concentrating a local concentration of the spores in the solution. The concentration step may be performed using at least one magnetic bead. The magnetic bead may comprise an antibody capable of binding to an antigen that is characteristic of the spore. Alternatively or additionally, the concentration step may be performed using a centrifuge. The concentration step may be performed using a flow cytometer. The concentration step may be performed using a filter, capillary action, chromatographic strips, solid surface, adsorption or absorption. The concentration step may be performed using other techniques such as filtration, adsorption and absorption to surfaces or particles, aerosol or air sampler. The released DPA may be concentrated or captured by a chromatographic or an immunostrip before detection by the dye-metal complex.

The luminescence of the second chelator or the metal ion may be monitored continuously as the sample is contacted with the reagent. The image may be taken using an optical imaging system that comprises an optical filter. The optical imaging system may provide lensless imaging onto a CCD array.

The method may be for detecting at least one spore, and wherein the luminescence of the second chelator or the metal ion from inside of the said spore is detected. The luminescence of the second chelator or the metal ion may be detected using an optical imaging system.

The method may be for detecting at least one spore, which method includes the steps of inserting a luminescent dye-metal complex into the at least one spore, and detecting a signal originating from the inside of the spore.

The method may be for detecting at least one spore, which method includes the steps of causing a luminescent dye and a metal ion to penetrate into the at least one spore, and detecting the luminescence of the dye using an optical imaging system.

The method may be for staining a compartment within a spore, which method includes the steps of causing a luminescent dye and a metal ion to penetrate into the compartment. The compartment may comprise DPA. The compartment may be stained with the luminescent dye in comparison to at least one other compartment.

In the methods of the invention, the at least one spore may be a bacterial endospore.

In the methods of the invention, the second chelator and the metal ion within the reagent may be selected to target a specific type of spore.

In the methods of the invention, the reagent may comprise an antibody that targets a specific type of spore.

In a particular embodiment, the invention provides a method for detecting at least one spore containing dipicolinic acid, which method includes the steps of providing a quenched luminescent dye-metal complex, which complex comprises a luminescent dye and a metal ion, releasing the dipicolinic acid from the at least one spore, contacting the quenched luminescent dye metal complex with the dipicolinic acid, exciting the luminescent dye with a light source to emit a luminescent signal, and detecting the luminescent signal with a detector.

In the methods of the invention, at least one of the dye and the metal ion may be selected to target a specific type of spore. In this way, the method may be used selectively to detect particular spores within a sample that may contain a mixture of different spores. Alternatively or additionally, the method may include the step of providing an antibody. The antibody, which is suitably specific for a particular type of spore, will be linked to the reagent comprising the dye and the metal so that the reagent becomes targeted to a specific type of spore.

The method may include the step of providing a selective growth media. Samples cultured in the selective growth media for instance as a preliminary step, will have the number of spores and in particular the number of target spores increased prior to detection.

The method may include the step of purifying the spores. This may be particularly useful where the sample is a mixed or crude sample and can be carried out as a preliminary step for example in removing spores from other matrices that they may be present in, such as food or clinical samples.

The methods of the invention may include the step of analyzing the luminescent signal in order to identify whether the spore is viable, non-viable, germinating, or germinated. The analyzing step may involve estimating an intensity of the luminescent signal. The analyzing step may involve estimating the location of the luminescent signal. The analyzing step may involve estimating the amount of DPA present.

The methods of the invention may include the step of releasing or extracting DPA from a compound of the DPA. By ‘compound’ in this instance it is meant DPA in any form associated or complexed with another ion or molecule, that may be covalently or non-covalently bound. The compound may be a chelate.

The methods of the invention may include exciting a luminescence of the second chelator and the metal ion, and detecting the luminescence emitted by the second chelator and the metal ion.

The invention also provides a reagent for detecting a first chemical chelator, which reagent comprises a luminescent second chelator and a metal ion, wherein when the metal ion is bound to the second chelator, the luminescence of the second chelator is altered, and wherein the metal ion is also capable of binding to the first chemical chelator in competition with the second chelators.

The first chemical chelator may be DPA. The first chemical chelators may be one that has a high binding affinity to lanthanides. Such chelates include polyamino carboxylic acids such as ethylenediaminetetraacetic acid (EDTA), dipicolinic acid, diaminopimelic acid (DAP), n-acetlymuramic acid, sulfolactic acid, and phosphoglyceric acid.

The second chelator may be a luminescent dye.

The reagent may comprise a luminescent dye and a metal ion complex, the metal ion is bound to the luminescent dye, the luminescence of the dye is quenched by the metal ion, the reagent being characterized in that the metal ion is capable of binding to the DPA, and the dye and the metal ion are such that the DPA can compete for the metal ion in competition with the dye, thereby dequenching the luminescence of the dye.

The dye may be such that it emits a luminescent emission after excitation by ultra violet light. The dye may be such that it emits a luminescent emission after excitation by visible light. The dye may be such that it emits a luminescent emission after excitation by infra red light.

The DPA may be present with calcium in the sample, for instance within a spore. In such cases, the reagent is suitably such that the metal ion and the second chelator are selected such that the luminescence of the second chelator is quenched more strongly by the metal ion than by calcium ions on a molar basis.

The reagent may be such that it is capable of detecting dipicolinic acid. The reagent may be such that it penetrates into a spore. The spore may be a viable non-germinating spore.

The reagent may be for detecting DPA from at least one spore. The spore may be a viable non-germinating bacterial endospore. The reagent may be for imaging at least one spore. The reagent may be for detecting at least one spore.

The reagent may be for distinguishing between viable and non viable spores.

The dye-metal complex may be such that it can penetrate into a spore. The spore may be a viable non-germinating bacterial endospore.

The dye may be such that it is not quenched by calcium.

The second chelators may be a luminescent dye. The luminescent dye may be a fluorescent dye. The fluorescent dye may be selected from the group comprising the following and their derivates: Calcein, resorufin, Fluorescein, rhodamine, texas red, Alexa fluor, DyLight, Cy3 and Cy5, Quantum dots, near infra red dyes, and fura dyes.

The luminescent dye may be calcein. The luminescent dye may be resorufin.

The metal ion may be selected from a group comprising a rare earth metal, an actinide, a transition metal, indium, tin, thallium, lead, and a bismuth ion. The metal ion may be a samarium, europium, terbium or dysprosium ion.

The metal ion may be selected such that when it binds to the first chelator (for example DPA) it forms a first chelate which chelate has a higher luminescence than the metal ion and when it binds to the luminescent dye it forms a second chelate which chelate has lower (quenched) luminescence than the luminescent dye.

The metal ion may be selected such that the association constant of the first chelator to the metal ion is at least ten times higher than the association constant of the first chelator to a calcium ion.

Different dyes are quenched to different levels by different metal ions. For instance Section 19.7 of the Invitrogen, The Handbook; A guide to fluorescent probes and labelling technologies; 10^{th} edition provides many such examples. Other dyes and metal can be identified by simply testing and comparing the fluorescence emission of the dye with and without metal ions and this way dye and metal match may be found. A further criteria may be that the metal ion should be displaced from the dye upon addition of DPA in order to dequench the fluorescence of the dye. When the dye-metal complex is used to stain intact spores, an additional criteria is that the complex is able to penetrate the spore structure to reach DPA located in its compartments.

The invention also provides an apparatus for detecting a chelating agent such as dipicolinic acid which apparatus provides means for contacting a reagent with a sample, and a detector for measuring a luminescent light signal, wherein the apparatus is arranged to detect a change in luminescence of the reagent on contact with the sample. The reagent may be one of those described above.

The invention also provides a spore that has been penetrated by a reagent comprising a reagent described above. The spore may be luminescent. The spore may be obtainable by a method according to the invention.

The invention also provides an endospore characterised in that it has been treated by permeating a reagent comprising a luminescent dye bound to a metal ion into the endospore, which endospore comprises a spore coat, at least one compartment, dipicolinic acid or a derivative thereof, the luminescent dye, and a plurality of the metal ion, wherein the spore coat surrounds the compartment, the compartment contains the dipicolinic acid, the luminescent dye has a characteristic luminescence when excited by the optical radiation, the metal ions when bound to the luminescent dye reduce the luminescence of the luminescent dye and increase the rate of diffusion of the luminescent dye through the spore coat; the metal ions bind to the dipicolinic acid in preference to binding to the luminescent dye; the luminescence of the dye is increased when the metal ion is released from the dye and binds to the dipicolinic acid, and the luminescent dye within the endospore luminesces when excited by optical radiation.

### BRIEF DESCRIPTION OF THE DRAWINGS

Embodiments of the invention will now be described solely by way of example and with reference to the accompanying drawings in which:

FIG. 1 shows the principle of DPA detection according to present invention;

FIG. 2 shows a diagram of cross section of a bacterial spore also known as endospore;

FIG. 3 illustrates how DPA within a spore can be detected by the present invention;

FIG. 4 shows a suspension of spores in a solution;

FIG. 5 shows magnetic beads providing a local concentration of spores within the solution;

FIG. 6 shows a magnetic bead comprising an antibody;

FIG. 7 shows an optical imaging system;

FIG. 8 shows the absorption and emission of a luminescent dye;

FIG. 9 shows a graph of fluorescence intensity of a dye versus concentration of a metal ion;

FIG. 10 shows a graph of fluorescence intensity of a dye-metal complex versus concentration of DPA;

FIG. 11 shows a plot of fluorescence intensity of a dye-metal complex against increasing concentration of DPA;

FIG. 12 shows a plot of fluorescence intensity of a dye-metal complex against increasing numbers of spores;

FIG. 13 shows a plot of fluorescence intensity of terbium against type of treatment used to release the DPA from spores before its detection by adding to the terbium solution;

FIG. 14 shows a brightfield photomicrograph image of spores using a dye-metal stain;

FIG. 15 shows a fluorescence photomicrograph image, shown in grey scale, of the same sample as in FIG. 14;

FIG. 16 shows a plot of fluorescence intensity of a reagent comprising a dye-metal complex encapsulated into unilamellar liposomes when released into an assay solution containing different concentrations of DPA. The arrow indicates the time point when triton X-100 is added to release the reagent;

FIG. 17 shows a fluorescence photomicrograph image, in grey scale, of the spores using a dye-metal stain;

FIG. 18 shows a fluorescence intensity against time for the dye-metal stain when either DPA (trace A) or calcium chloride (Trace B) is added after certain (X) period of time;

FIG. 19 shows a graph of fluorescence intensity of a dye-metal versus time after the addition of spores; The dotted line is only drawn for the purpose of calculating the rate of signal formation;

FIG. 20 shows a fluorescence photomicrograph image in grey scale of the spores captured with magnetic bead and stained using dye-metal stain;

FIG. 21 shows a fluorescence photomicrograph image in grey scale of the clostridium difficle spores stained using dye-metal stain;

FIG. 22 shows a bar graph of fluorescence intensity one hour after adding spores to a dye solution without the metal ions. The type of treatment used to release the DPA is given on the x-axis;

FIG. 23 shows a bar graph of fluorescence intensity one hour after adding spores to dye-metal solution. The type of treatment used to release DPA is given on the x-axis;

FIG. 24 shows a bar graph of percentage fluorescence intensity when metal is added (grey bars) to the dye and also when DPA is added (black bars) to this same metal quenched solution. The percentage fluorescence intensity was calculated by dividing the fluorescence intensity observed by the fluorescence intensity of dye alone (in the absence of the metal ions and DPA) and then multiplying by 100;

FIG. 25 shows a bar graph of percentage fluorescence intensity when metal is added (grey bar) to Phen Green dye and also when DPA is added (black bars) to this same metal quenched solution. The % fluorescence intensity was calculated by dividing the fluorescence intensity observed by the fluorescence intensity of dye alone (in the absence of the metal ions and DPA) and then multiplying by 100;

FIG. 26 shows an epifluorescence photomicrograph image in grey scale of the Bacillus spores stained using dye-metal stain where the metal is europium. The scale bar is 10 microns as shown in the white box on the image;

FIG. 27 shows a fluorescence photomicrograph image in grey scale of the Bacillus cereus endospores (indicated by an arrow) inside bacterial cells or sporangia when stained using dye-metal stain. The scale bar is 10 microns as shown in the white box on the image;

FIG. 28 is a graph illustrating the emission spectrum of resorufin (spectrum 1) in the presence of europium (spectrum 2) and when DPA is added (spectrum 3) to europium quenched resorufin solution;

FIG. 29 shows an epifluorescence photomicrograph image in grey scale of the Bacillus cereus endospores after capturing by centrifugation and staining using dye-metal stain;

FIG. 30 shows the emission spectra of dye-metal stain, with and without DPA at the excitation wavelength of the terbium-DPA complex;

FIG. 31 shows the emission spectrum of 0.12 μM solution of a Calcein-terbium stain (no chelator spectrum) using an excitation wavelength of 485 nm with and without the 100 μM of chelator addition; and

FIG. 32 shows similar results to FIG. 31 for chelators that showed a much smaller change in fluorescence compared to the chelators of FIG. 31.

### PREFERRED EMBODIMENT

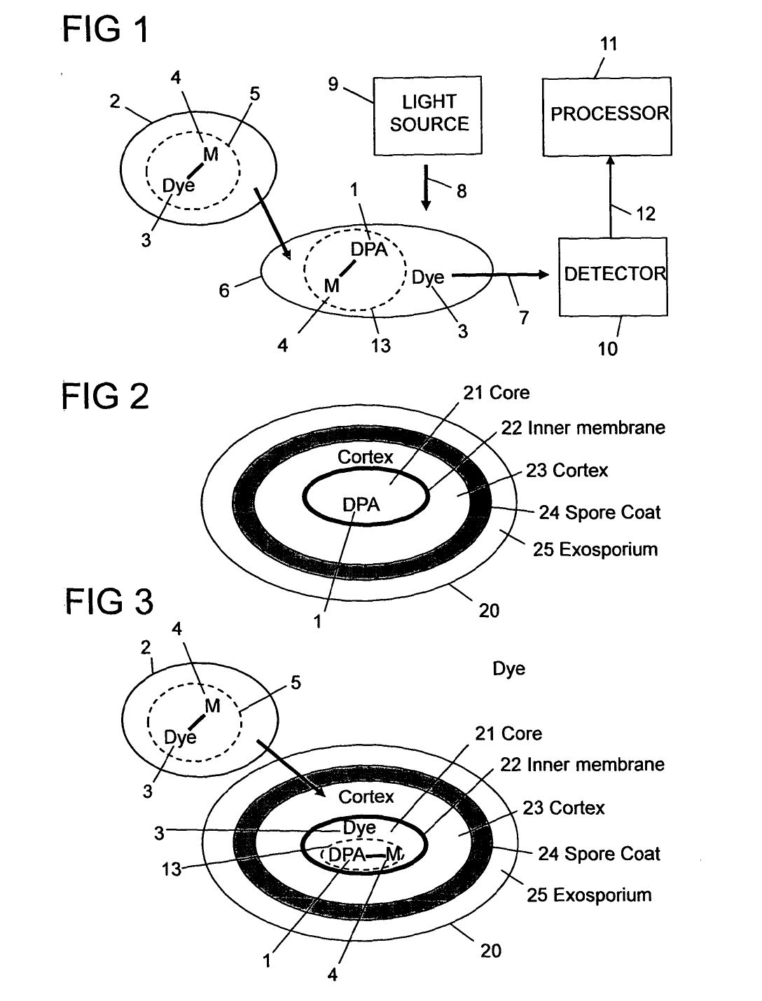

FIG. 1 shows a method for detecting a first chelator (shown in the figure as dipicolinic acid DPA 1), the method comprising the steps of providing a reagent 2 comprising a second chelator (shown as a luminescent dye 3) and a metal ion 4, contacting the reagent 2 with a sample 6 containing the DPA 1, exciting a luminescence 7 of the dye 3, and detecting the luminescence 7 emitted by the dye 3, the method being characterized in that the metal ion 4 is bound to the luminescent dye 3 within the reagent 2, the luminescence 7 of the dye 3 is altered by the metal ion 4, the metal ion 4 is capable of binding to the DPA 1, and the dye 3 and the metal ion 4 are such that the DPA 1 can compete for the metal ion 4 in competition with the dye 3, thereby re-establishing the luminescence 7 of the dye 3.

The alteration of the luminescence 7 can be in a positive or a negative sense. Thus the luminescent dye 3 can be such that the luminescence 7 is quenched by the metal ion 4, and dequenched in the presence of the DPA 1. For instance this occurs when the luminescent dye 3 is calcein, and the metal ion 4 is terbium. Alternatively, the luminescent dye 3 can be such that the luminescence 7 is enhanced by the metal ion 4, and re-established when the metal ion 4 is chelated in the presence of the DPA 1. An example is where the dye 3 is a charge transfer exciplex comprising pyrene, and the metal ion 4 is silver.

Also shown in FIG. 1 is a light source 9 selected to provide pump radiation 8 for exciting the luminescent dye 3, a detector 10 for detecting the luminescence 7, and a processor 11 for processing the output 12 of the detector 10. The light source 9 can be such that it only excites the luminescent dye 3. Alternatively, the light source 9 can be selected to excite both the luminescent dye 3 and a luminescence of the metal ion 4. This latter approach can provide additional signal amplification and enhanced selectivity.

The luminescent dye 3 and the metal ion 4 are shown as forming a dye metal-ion complex 5 within the reagent 2. When this complex is contacted with the DPA 1, the metal ion 4 is displaced by the DPA 1, and the luminescence 7 of the dye 3 becomes dequenched (that is, relieved or in other words increased in intensity). The dye metal-ion complex 5 forms an equilibrium with the dye 3 and the metal ion 4 that is controlled by the DPA 1, as shown in the following equilibrium equation.

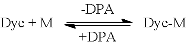

On the right hand side, the dye 3 and the metal ion 4 are shown complexed, that is, they are bound together. Adding the DPA 1 (as shown by the bottom arrow) shifts the equilibrium to the left, where the dye 3 and the metal ion 4 are shown in free form, that is, unbound. Similarly, removing the DPA 1 (as shown by the top arrow) shifts the equilibrium to the right, and the dye 3 and the metal ion 4 become bound. The fraction of the dye 3 in the bound and the unbound state is determined by the level of the DPA 1 present. The intensity of the luminescent signal 7 resulting from the unbound dye 3 (on the left hand side) is indicative or proportional to the concentration of the DPA 1 present. To be clear the luminescence of dye in the bound state is quenched and that in the unbound state is dequenched. By “quench” it is meant that the luminescent intensity becomes low and by “dequench” it is meant that the luminescent intensity increases from the quenched state, and preferably is re-established to its pre-quenched state.

Referring to FIG. 1 again, the arrow extending from the reagent 2 to the sample 6 indicates adding the reagent 2 to the sample 6. Once added, the reagent 2 encounters the DPA 1, the metal ion 4 transfers from the dye 3 to the DPA 1, thus forming the DPA metal complex 13. The dye 3 is then unbound and is no longer quenched.

The invention is particularly advantageous for detecting particles, such as bacterial endospores (or spores), that contain or release DPA. FIG. 2 shows a cross-section of a spore 20. The spore 20 comprises a core 21, and a cortex 23 that surrounds the core 21. The cortex 23 is enveloped by a spore coat 24 (shown shaded grey), which in certain spores is surrounded by an exosporium 25. The core 21 and the cortex 23 are separated by an inner membrane 22. For clarification purposes, the label 21 points to an arbitrary region within the core 21, the label 23 points to an arbitrary region within the cortex 23, and the label 25 points to an arbitrary region within the exosporium 25. DPA 1 is shown located within the core 21 of the spore 20; it is typically present as calcium dipicolinate. Depending on the nature and the state of the spore, DPA may also be present in the other compartments. As used herein, DPA is meant to include not only dipicolinic acid, but also a compound of the DPA as defined above. The core 21 also comprises deoxyribonucleic acid (DNA). The core 21, cortex 23, and the exosporium 25 are also referred to as “compartments”.

The invention described with reference to FIG. 1 is an example of a more general invention for detecting a chelator such as the DPA 1. Suitable chelators are those that have high binding affinity to lanthanides. Such chelates include polyamino carboxylic acids such as ethylenediaminetetraacetic acid (EDTA), dipicolinic acid, diaminopimelic acid (DAP), n-acetlymuramic acid, sulfolactic acid, and phosphoglyceric acid. The chelators may be ethylenediaminetetraacetic acid (EDTA). The chelator may be a related marker that is found within spores, such as dipicolinic acid DPA, diaminopimelic acid (DAP), n-acetlymuramic acid, sulfolactic acid, or phosphoglyceric acid. The chelator may in the form of a chelate within the spore.

Endospores are probably the most durable form of life known. Mature spores have no detectable metabolism, a state that is described as cryptobiotic. They can remain viable for extremely long periods of time, perhaps millions of years. They are highly resistant to environmental stresses such as high temperature (some endospores can be boiled for several hours and retain their viability), irradiation, strong acids, disinfectants, etc. Although cryptobiotic, they retain viability indefinitely such that under appropriate environmental conditions, they germinate into vegetative cells. Their durability is assisted by the spore coat 24, which in many spores comprises calcium. The exosporium 25 and the spore coat 24 also makes the spores 20 highly resistant to simple dyes and stains.

Despite their renowned durability, the inventors have discovered that it is possible to penetrate the exosporium 25 and the spore coat 24 with a luminescent dye 3 that has been quenched with a metal ion 4. The principle is shown in FIG. 3. As in FIG. 1, the reagent 2 comprises the luminescent dye 3 and the metal ion 4. They form the complex 5. Upon penetrating the spore coat 24, the luminescence of the dye 3 is dequenched when it encounters DPA either in the core 21 or the cortex 23, and the dye 3 can be detected, for example according to the method described with reference to FIG. 1. Without limiting the scope of the invention in any way, it is believed that upon penetrating the spore coat 24, the DPA 1 displaces the dye 3 from the metal ion 4, thus relieving the luminescence of the dye 3. The luminescence of the dye 3 is thus indicative of the presence of the DPA 1 within the spore 20. The intensity of the luminescence 7 is indicative or proportional to the amount of the DPA 1 present. The DPA 1 and the metal ion 4 is shown as forming the DPA-metal complex 13 within the core 23. However a similar complex can form in any compartment where the DPA 1 may be present.

The DPA 1 may be present as DPA or as calcium dipicolinate within the spore 20, for example within the spore core 21, spore cortex 23, spore coat 24 or the exosporium 25 depending on the state of the spore. This is because when the spore forms, DPA will leach into the outer layers of the spore, including the mother cell. As the mother cell dies away, any DPA 1 present will leach away. Similarly, if the spore 20 becomes damaged (for example by cleaning with sporocidal agents, including physical treatments such as heat and sonication, the DPA leaks out, including into the outer spore layers and into the bulk solution. If the spore at that point does not germinate, then it is easily damaged and dies. Consequently, the amount of DPA present and its location is an indicator of the viability of the spore. The state of the spore may be viable, non-viable, viable non culturable, or damaged. Therefore depending on the state of the spore the DPA 1 may leach from one compartment to another. Hence it may be possible to determine the state of the spore 1 depending on which compartments become stained or on the relative intensities of staining within the different compartments.

This discovery provides significant advantages over the prior art. It was previously known to detect spores 20 by using dyes that detect the presence of calcium, nucleic acids and phopholipids. Without limiting the invention in any way, it is believed that the poor penetration may be because dyes used to stain calcium, DNA and phospholipids are highly charged and therefore are only able to weakly penetrate the spore 1 resulting in poor staining.

The present invention of using the luminescent dye 3, that has been quenched with the metal ion 4, to penetrate the spore 20 solves the poor contrast problems of simply detecting calcium, as well as the weak signal problems of using a luminescent metal ion. Importantly, it also allows, a single compartment, such as the cortex 23 or the core 21, which is rich in DPA, to be preferentially stained by the dye 3. The invention allows stained spore compartment to be imaged with an imaging system such a microscope. The ability to preferentially stain a DPA rich compartment within the spore is believed to have important implications for researching and exploiting the microbiology of spores.

The dye-metal complex 5 is able to permeate into the spore 20. If the spore 20 comprises an exosporium 25, the dye-metal complex 5 is able to cross the exosporium 25. The spore 20 can be a viable non-germinating bacterial endospore. Many spores 20 contain DPA, for example within the core 21 or the cortex 23. Thus exciting the luminescence 7 of the dye 3 by the method described with reference to FIG. 1 allows the spore 20 to be detected, for example, by imaging with an optical microscope. It also allows many of the spores 20 to be detected within the sample 6.

Alternatively or additionally, the DPA 1 can be released from the spore 20 into solution. This can be achieved, for example, by physical (heat, microwave, sonication), chemical (dodecylamine) or biochemical (germinating spores with L-alanine). The DPA 1 can then be detected by the method described with reference to FIG. 1.

The invention therefore provides a method for detecting at least one spore 20 containing the DPA 1, which method includes the steps of providing the quenched luminescent dye-metal complex 5, which complex 5 comprises the luminescent dye 3 and the metal ion 4, releasing the DPA 1 from the at least one spore 20 into a solution (not shown). The quenched luminescent dye metal complex 5 can then be contacted with the DPA 1, for example, by adding the complex 5 to the solution. The luminescent dye 3 can then be excited with the light source 9 to emit the luminescent signal 7, and luminescent signal 7 detected with a detector 10. It is believed that the luminescence of the quenched luminescent dye metal-complex 5 becomes dequenched when in contact with the DPA 1.

Alternatively or additionally, the method can be used to detect at least one spore 20 which contains a spore coat 24, which method includes the steps of providing the quenched luminescent dye-metal complex 5, which complex 5 comprises the luminescent dye 3 and a metal ion 4 and causing the dye-metal complex 5 to cross the exosporium 25, for example by adding the complex 5 to the sample 6. The luminescent dye 3 can then be excited with a light source 9 to emit a luminescent signal 7, which can be detected with a detector 10.

As will be shown below, the dye-metal complex 5 can be selected to target a specific type of spore. For example, viable or mature bacterial endospores contain DPA, whereas non-viable or immature bacterial endospores either contain no DPA, or much less DPA. Thus spores in different stages of maturation and different viable states can have varying levels of DPA. It is known that when spores germinate, the spore coat and the inner membranes become more permeable, such that high levels of DPA is released from the core through the core cell inner membrane through the cortex over a period of hours. During this time the germinating spore can be stained, and the stain would penetrate more deeply into the spore, including into the core. After a period of hours, once all or some of the DPA has leached away, the spores do not stain as brightly as prior to leaching, and may not stain at all. Viable spores will have more intense luminescent signals than non-viable spores. The germinating spores will have luminescent signals that will extend further into the spore and depending on the extent of germination, into the core. Germinating spores will have the lowest strength luminescent signal. Analyzing the luminescent signal 7, for example, by comparing the strength of the luminescent signal 7 with the strength from previously known samples, or by mapping the relative concentrations of the luminescent signal within the spore thus provides a method for the detection of intact viable and non-viable spores, as well as germinating or germinated spores.

Similarly, pollen, viruses, and spores from fungi do not contain DPA. Thus the invention can be used to distinguish spores that contain DPA (such as bacterial endospores) from pollen, viruses, and spores that do not contain DPA (such as fungal spores) by using a luminescent dye metal complex 5 that is dequenched relieved by the DPA 1 present in the spore 20.

Preferably, the metal ion 4 and the dye 3 should be selected such that the luminescence of the dye 3 is quenched more strongly by the metal ion 4 than by calcium ions on a molar basis. This ensures that the calcium in the spores or the sample will not have a significant effect on diminishing the fluorescence of dye 3 thus allowing higher sensitivity. To provide further signal amplification, the dye 3 may be such that it has a higher fluorescence in presence of calcium once the dye 3 has been dequenched by DPA.

The luminescent dye 3 can be a fluorescent dye that is quenched by the metal ion 4 but not by calcium. Alternatively or additionally, the fluorescent dye can be selected from the list provided in Table 1. These have different excitation and fluorescent wavelengths, some of which may be more convenient than others for different applications. The term “derivatives” is also meant to include “analogues”.

TABLE 1

Fura-2, Indo-1 and derivatives
Quin-2 and derivatives
Fura-4F, Fura-5F & Fura-6F; Benzothiaza-1 & Benzothiaza-2
Fura-FF, BTC, Mag-Fura-2, Mag-Fura-5, Mag-Indo-1
Fluo-3, Rhod-2 and related derivatives
Fluo-5N, Rhod-5N, X-Rhod-5N and related derivatives
Calcium Green, Calcium Orange and Calcium Crimson indicators
Oregon Green 488
Fura Red indicator
Calcein and its derivates
Resorufin and its derivatives

The luminescent dye 4 may be a fluorescent dye. The fluorescent dye may be selected from the group comprising the following and their derivates: Calcein, resorufin, Fluorescein, rhodamine, texas red, Alexa fluor, DyLight, Cy3 and Cy5, Quantum dots, near infra red dyes, and fura dyes.

Preferably, the metal ion 4 has a higher affinity for the DPA 1 than calcium. The DPA 1 can then efficiently displace the metal ion 4 even when the DPA 1 is present as calcium dipicolinate.

The metal ion 4 can be monovalent or multivalent. The metal ion 4 can be a rare earth ion. The rare earth ion can be a lanthanide, which may be selected from the group consisting of lanthanum, cerium, praseodymium, neodymium, promethium, samarium, europium, gadolinium, terbium, dysprosium, holmium, erbium, thulium, ytterbium, and lutetium. In an embodiment, the rare earth ion is europium or terbium.

The metal ion 4 can be selected from a group comprising a rare earth metal, an actinide, a transition metal, indium, tin, thallium, lead, and a bismuth ion. The metal ion 4 can be a samarium, europium, terbium or a dysprosium ion. Such ions are known to form highly luminescent chelates with DPA 1 as a result of energy transfer.

The metal ion may be selected such that when it binds to the first chelator (for example DPA) it forms a first chelate which chelate has a higher luminescence than the metal ion and when it binds to the luminescent dye it forms a second chelate which chelate has lower (quenched) luminescence than the luminescent dye.

The metal ion 4 may be selected such that the association constant of the first chelator (such as the DPA 1) to the metal ion 4 is at least ten times higher than the association constant of the first chelator to a calcium ion. The association constant may be at least one hundred times higher. The association constant may be at least one thousand times higher. The higher the association constant, the more reliable the reaction between the reagent and the first chelator.

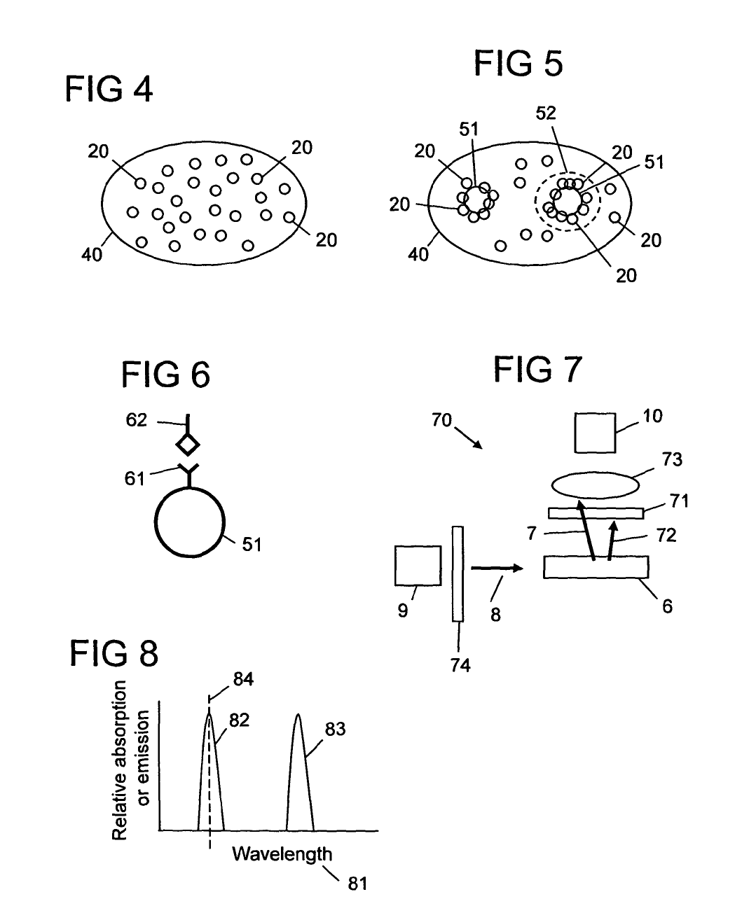

The sample 6 can comprise a plurality of the spores 20 in a solution 40, as shown with reference to FIG. 4. As shown in FIG. 5, the above methods may include the step of concentrating a local concentration 52 of the spores 20 in the solution 40. The concentration step can be performed using at least one bead 51. As shown in FIG. 6 the bead 51 may comprise an antibody 61 capable of binding to an antigen 62 that is characteristic of the spore 20. The bead 51 may be any solid particle. For instance it may be a polymer such as latex, a metal such as a paramagnetic or magnetic bead, a particle such as a liposome, or simply a solid surface. Alternatively or additionally, the concentration step may be performed using a centrifuge or a flow cytometer, filtration, adsorption and absorption onto surfaces or particles, aerosol or air sampler, Alternatively or additionally, the released DPA may be concentrated or captured by chromatography or an immunostrip before detection by the dye-metal complex 5. The antibody 61 either alone or in combination with the bead 51 can also be used to detect the presence of a single spore 20. Whether for single spores or a plurality of spores, use of the antibodies can increase the specificity of an assay.

FIG. 7 shows how an optical imaging system 70 may be used with the above methods. The sample 6 is illuminated by the pump radiation 8 from the optical source 9. The luminescence 7 of the dye 3 is shown being imaged onto the detector 10 by the lens 73. FIG. 8 shows a graph of the absorption band 82 and the emission band 83 of the luminescent dye 3 versus wavelength 81. The wavelength 84 of the pump radiation 8 can be within the absorption band 82. Alternatively, the wavelength 84 can be a multiple (such as two times or three times) the wavelength of the absorption band if the excitation of the luminescent dye 3 is by multi-photon absorption, which has advantages in terms of localisation, avoiding unwanted overlap of excitation and emission wavelengths, and the ability to use cheaper plastics and other materials in the system that will not auto fluoresce at these longer excitation wavelengths. An excitation filter 74 can be provided to remove any unwanted pump radiation from the source 9 reaching the sample 6. The unwanted radiation comprises radiation wavelengths that are not able to excite the dye 3. Referring again to FIG. 7, a filter 71 can be provided to remove any unwanted signals 72 emerging from the sample 6. The unwanted signal 72 can be scattering of the pump radiation 8, or can be an unwanted luminescence of plastics or other materials used to hold the sample 6. The filters 71 and 74 can comprise at least one of an optical filter such as an optical interference filter, a grating, a monochromator, or a double monochromator. The detector 10 can comprise a semiconductor detector, a photomultiplier, a charge coupled device (CCD) array, a camera, or can be provided by the human eye.

If the detector 10 is sufficiently close (preferably less than 1 mm) to the sample 6, then the lens 73 can be emitted, and the optical imaging system 70 is then a lensless optical imaging system. If the detector 10 is a semiconductor array, such as a CCD array or a CMOS array, then the optical imaging system can provide lensless imaging onto the array. Such an array can be used to provide images of spores contained within the sample 6, such imaging being provided by refraction, diffraction, or a combination of refraction and diffraction. Then the lensless optical imaging system would include the filter 71, preferably in the form of an optical coating. The lens 73 can also be a fibre optic bundle for transmitting the signal 7 to the detector 10 which is preferably in the form of a CCD array or a CMOS array. The fibre optic bundle can provide magnification. Fibre optic bundles are available from Roper Scientific GmbH of Ottobrunn, Germany.

The above methods can thus provide a method for detecting at least one spore 20, which method includes the steps of inserting the luminescent dye-metal complex 5 into the at least one spore 20, and detecting the signal 7 from the inside of the spore 20.

The methods described with reference to FIGS. 1 to 8 provide a method for detecting at least one spore 20, which method includes the steps of causing a luminescent dye 3 and a metal ion 4 to penetrate into the at least one spore 20, and detecting the luminescence 7 of the dye 3 using an optical imaging system 70. Advantageously, these methods can include the use of the antibody 61, either alone, or in combination with a surface such as the bead 51, to provide a specific assay for a spore.

The above methods are particularly advantageous when the at least one spore 20 is a bacterial endospore.

Referring again to FIG. 3, the dye 3 is bound to the metal ion 4 to form a dye-metal complex 5 that quenches the luminescence 7 of the dye. When this dye metal complex 5 encounters DPA 1, for example the DPA 1 present inside the spore 20, the metal ion 4 becomes dissociated from the dye 3 resulting in dequenching or relieving of the dye luminescence 7 thereby increasing its luminescence. If the dye 3 is retained near the spore 20 or in the compartment such as the core 21 or the cortex 23, the dye 3 acts as a fluorescent stain providing a localized higher-intensity signal. If the dye 3 is released outside the spore 20 or a bacteria, the strength of the luminescence 7 emitted can provide a measure of the amount of the DPA 1 present, and hence can provide the total spore count. Alternatively or additionally, the stained spores 20 may be counted microscopically to determine the total count. Such a counting technique can be used to provide reference or calibration data in order to provide the total viable spore count from the strength of the luminescence 7 and the number of spores.

Suitable metal ions 4 are those which quench the luminescence 7 of the dye 3. To find a suitable metal ion 4, the dye 3 is dissolved in buffer and its luminescence emission 7 recorded. Then the test metal ions 4 are added and the change in luminescence emission recorded. Preferably the suitable metal ion 4 will result in lowering of the luminescence signal 7. Once a suitable ion is identified it further needs to be confirmed that the metal ion 4 is also capable of binding to the DPA 1 (or to another suitable target) in the presence of the dye 3. This can be done in number of ways, for example, by direct binding assays with metal using spectroscopy or any of the other methods which are commonly used to measure equilibrium constants. Preferably the DPA 1 is added to the metal quenched dye 5, and dequenching observed to indicate displacement of the metal 4 from the dye 3. When both these criteria are met final verification can be made by preparing a mixture of the metal dye complex 5 having a quenched signal and adding the DPA 1 to this solution. The luminescence emission 7 will increase when the DPA 1 is added if the test has been successful. A third criteria may need to be fulfilled when testing the DPA 1 from spores 20. In this case the metal quenched dye 5 must be able to show recovery of luminescent signal 7 when the DPA 1 is added in the presence of calcium. This is because calcium is usually found in the spores 20 associated with DPA 1 or other chemical chelators. When the metal dye complex 5 is used as a stain a fourth criteria may need to be fulfilled. In this case the metal quenched dye 5 must be able to penetrate into the spore to contact DPA within one or or more of its compartments.

Lanthanide ions may be preferred as the metal ion 4, as they are known to have high affinity for DPA 1. However, in addition the lanthanide ions need to be able to quench the luminescence 7 of the dye 3.

Alternatively or additionally, to find a suitable dye 3, the metal ion 4 may be screened first with its ability to bind to the chemical chelators such as DPA 1, and then this metal ion 4 may be tested with respect to its ability to change and preferably quench the luminescence 7 of the dye 3.

There are many other techniques to study binding of metal ions 4 to chelators and dyes including dialysis, chromatography, spectroscopy. Any such technique may be used to identify a suitable metal ion 4 and dye 3. The key aspect is that the metal ion 4 must be able to compete for binding to DPA and the dye. Ideally the competition is in favour of DPA binding to the metal ion 4 rather than the dye binding to the metal ion 4. This can be assured by selecting a metal ion 4 that has a higher affinity to DPA than the dye.

Bacterial spores are often named as endospores, because they are formed intracellular, although they are eventually released from their mother cell as free spores. The term “spore” includes endospore and can be used interchangeably when discussing DPA diagnostic applications. Luminescence means emission of photons from the dye 3 after it has been excited at its excitation wavelength. Fluorescence is a form of luminescence.

### Example 1

Several fluorescence dyes, including fluorescein, rhodamine and calcein, were screened for their ability to bind to zinc, cobalt, terbium, aluminium, and several other metal ions. Their fluorescence emission was recorded before and after adding the metal ion. Many of these show quenching of the fluorescence. One of the efficient dyes was calcein whose fluorescence was quenched by a number of different metal ions including ions of zinc, cobalt, iron and terbium. These ions were tested for their ability to bind to DPA. The binding ability to DPA is variable in terms of affinity. Preferably the metal ion and the dye are selected such that the DPA has a higher affinity to bind to the metal ion than the dye binding to the metal ion for sensitive detection. From this study, terbium and europium were found to be two of the most efficient metal ions in terms of their quenching effect on calcein and ease of dequenching with DPA. although many others were also shown to have potential. Similarly calcein was found to be one of the most efficient dyes although many others were also shown to have potential.

### Example 2

Calcein and terbium (III) chloride hexahydrate, europium (III) chloride hexahydrate, cobalt (II) chloride hexahydrate, lead (II) chloride, calcium chloride and other general chemicals and solvents were purchased from Sigma-Aldrich (UK).

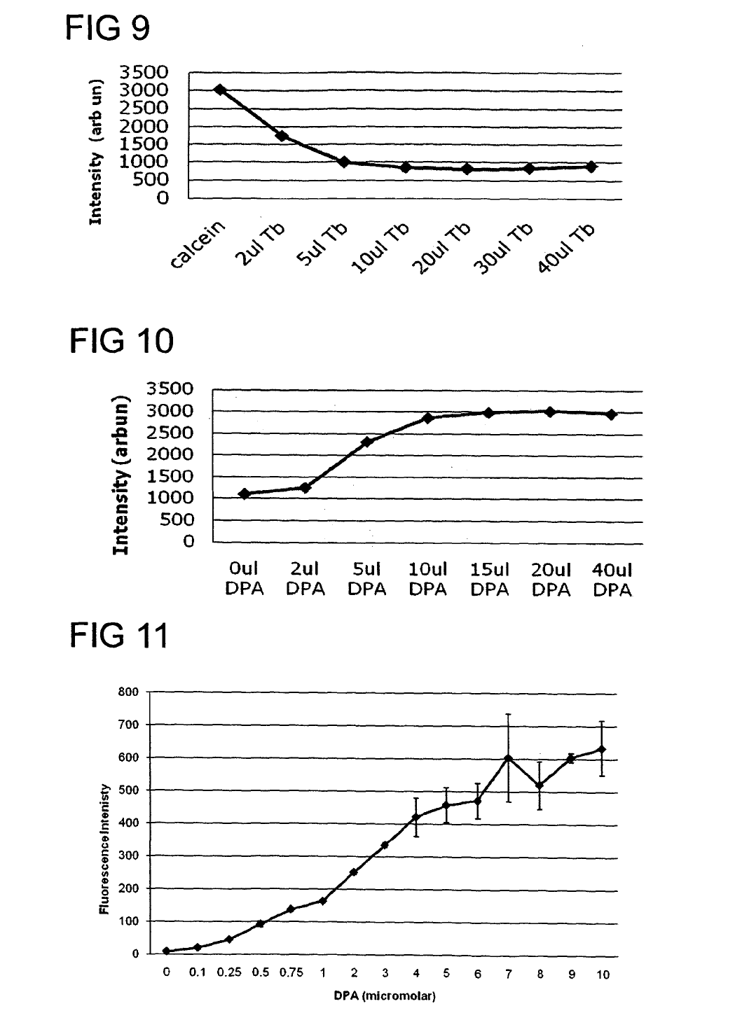

Calcein was selected as the luminescent dye 3, and terbium as the metal ion 4. The fluorescence emission signal 7 was recorded using an excitation wavelength (λex) 82 of calcein set at 485 nm and the emission wavelength (λem) 83 set at 520 nm. FIG. 9 shows the quenching of the fluorescent signal when a fixed concentration of calcein (1.2 μM) is titrated with various aliquots (μL) of terbium chloride (2 mM) solution. As more and more terbium chloride is added, the fluorescence signal drops. From this quenching curve a ratio of greater than four terbium ions per calcein molecule was found to quench the fluorescent signal efficiently. Therefore from such information, quenched solutions of calcein and terbium mixture could be prepared for testing. To reduce the background to a minimum, an excess of terbium chloride could be used in some applications. For instance from the information in FIG. 9 we prepared a quenched solution comprising 1.2 μM Calcein and 19 μM of terbium chloride by suspending in 10 mM TES 150 mM Sodium Citrate buffer. Then dissolution was achieved by the addition of 5M NaOH until the solution was clear, the pH was returned to 7.4 via the addition of 1M HCl. This quenched solution of calcein and terbium was then used to test the ability of DPA 1 to displace the terbium from the calcein. To do this the quenched solution was titrated with various aliquots (μL) of 2 mM DPA solution. DPA (2,6-Pyridinedicarboxylic acid) was purchased from sigma-Aldrich. FIG. 10 shows the recovery of the calcein fluorescence in response to addition of DPA in μL volumes. Wavelengths used λex=485 nm and λem=520 nm. The figure demonstrates that as dequenching occurs the fluorescence is recovered (ie relieved or re-established) as more and more DPA is added. The fluorescence intensity is particularly high above approximately 10 μL of DPA which is approximately equivalent to the stochiometric amount of terbium used.

### Example 3

A dilute solution comprising calcein and terbium chloride in 1:8 molar ratio, respectively, was prepared in 10 mM TES buffer pH 7.4. Various amounts of DPA were titrated into this solution and changes in fluorescence intensity of calcein measured using an excitation wavelength of 485 nm and emission at 520 nm. FIG. 11 shows the dose response curve for DPA detection.

Further optimization of this assay and reagents including molar ratio and nature of dye and metal used may produce dose response curves with even higher sensitivity.

It is also possible to use the invention to detect chelators other than DPA. Different chelators may respond differently depending on their binding affinities to the metal. To illustrate how a suitable chelator may be identified the fluorescence emission spectrum of the calcein-terbium stain was recorded in the presence and absence of DPA, EDTA, Lactic acid, 2,6-Diaminopimelic acid (DAP), N-Acetylmuramic acid and acetic acid.

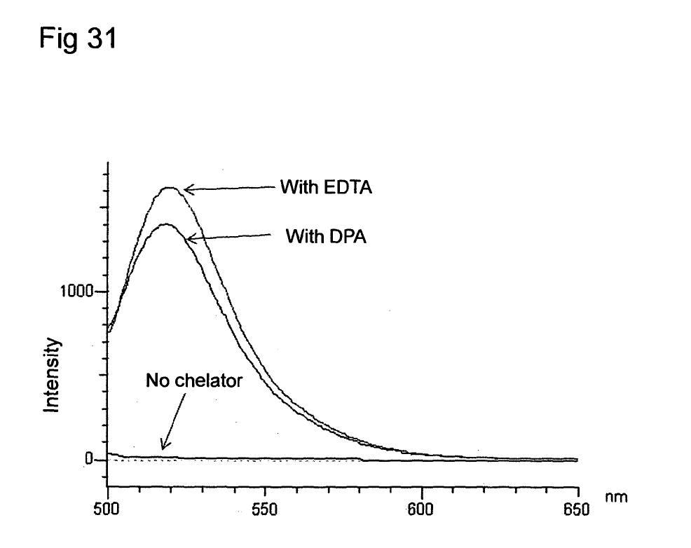

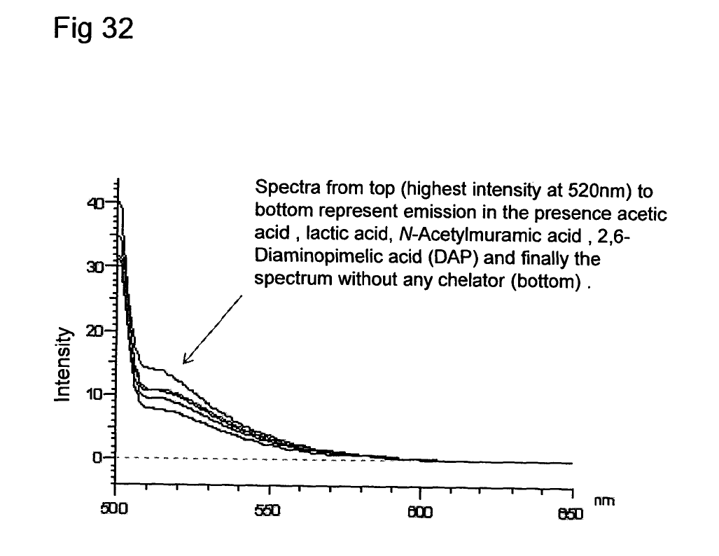

FIG. 31 shows the emission spectrum of 0.12 μM solution of calcein-terbium stain (no chelator spectrum) using an excitation wavelength of 485 nm. When 100 μM of chelator is added the emission spectrum shows a large increase in fluorescence emission for ethylenediaminetetraacetic acid (EDTA) indicating that this could be used as a chelator other than DPA. In contrast, FIG. 32 shows the fluorescence emission increase for other chelators, namely Lactic acid, 2,6-Diaminopimelic acid (DAP), N-Acetylmuramic acid and acetic acid. The increase was only marginal (note the expanded Y-axis compared to FIG. 31), indicating that the detection of these chelators with this particular dye and metal in this particular experiment shows less potential. However it is worth pointing out that a change in assay conditions such as changing the pH may show different potential.

The results of FIGS. 31 and 32 illustrates that the presence of common markers such as acetic acid and lactic acid is not likely to interfere with the detection of DPA which shows relatively large increase in signal intensity at 520 nm compared to lactic acid showing very little increase as shown in FIG. 31 with expanded Y axis.

### Example 4

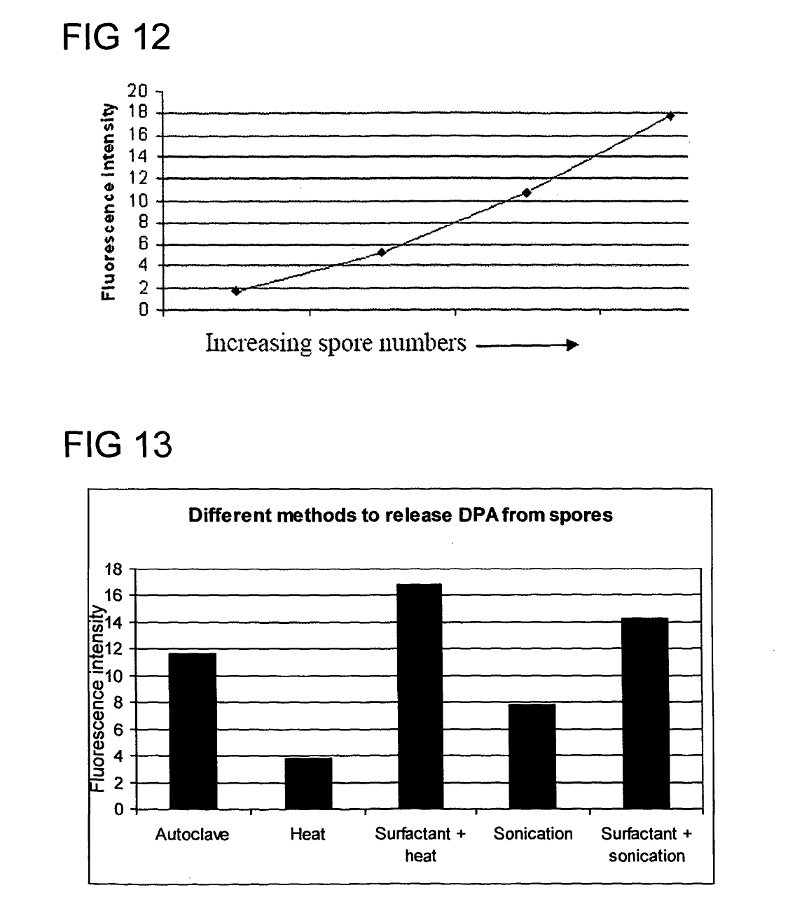

Bacillus cereus spores, ATCC 11778, were purchased (Raven-Laboratories Inc) in suspended form. Spore suspensions containing different number of spores per mL of 10 mM Tris-pH 8 buffer containing calcein-terbium stain having 0.604 calcein were taken and heated at 80 degrees Centigrade for 5 minutes to release some of the DPA from the spores. The suspension was cooled for 5 minutes and then fluorescence was recorded. Wavelengths were set to detect calcein excitation and emission at λex=485 nm and λem=520 nm. FIG. 12 shows recovery of calcein fluorescence in response to increasing number of Bacillus cereus spores. Increasing the spores by 6 orders of magnitude caused fluorescence intensity to double in bulk assay. Signal increase could also be related to DPA content measured by the conventional DPA terbium assay.

The sensitivity of the assay could be further improved by orders of magnitude by optimizing the ratio of calcein to terbium ions, and changing the conditions of the method to release DPA from spores. For example, FIG. 13 shows detection of DPA as indicated by an increase in fluorescent intensity (Y axis) of terbium using the conventional prior-art Terbium chloride assay. In this experiment Bacillus cereus spore suspension received five different treatments, described on the x-axis, to release DPA. For the assay spore suspension equivalent to 3.5×10⁶ spores per mL of solution was used. The treatments were applied for 5 minutes and then solutions allowed to recover for a further 5 minutes before adding to a cuvette having 2 ml of 10 mM Tris-HCL buffer pH 8 containing 30 μM terbium chloride. For sonication a bath (Ultrawave Ltd) was used, for heat treatment spore samples were incubated at 80 degrees centigrade for 5 mins. Dodecylamine was used as a surfactant at 1 mM concentration. When dodecylamine was used in combination with heat or sonication, it was added before applying heat or sonication. In all cases, the final reading was after 10 minutes from adding spores to the terbium chloride solution. The terbium fluorescence was recorded at 550 nm with an excitation wavelength of 278 nm. This conventional assay shows that DPA release can be mediated by various treatments. Such methods could be used to release DPA which may then be detected by a dye-metal stain such as described with reference to FIGS. 1 to 3.

### Example 5

### Detection of DPA within Spores

A solution of calcein and terbium was prepared comprising 1.2 mM calcein and 10 mM terbium in 10 mM Tes pH 7.4 buffer. This is the stock stain solution which from hereon is referred to as the 1.2 mM Calcein-terbium stain or simply stain. For microscopy experiments the final concentration used was 1.2 μM of this stain. Such solutions were then used as a calcein-metal stain to visualize spores microscopically by the method below.

Bacillus cereus spores, ATCC 11778, were purchased (Raven-Laboratories Inc) in suspended form and diluted to 1×10⁷ spores per millilitre. An aliquot of the spore suspension was placed on a microscope slide using an inoculation loop. This was fixed to the slide by air drying. The slide was flooded with a solution of the calcein-terbium stain (1.2 μM) prepared above. Another slide was prepared in the same way but this time it was gently heated over a Bunsen flame. Both slides were washed with deionised water to remove any excess unbound material. The slides were dried and examined under a Leica SP5 upright microscope. Images were recorded under brightfield mode and fluorescence mode. For fluorescence images Fluorescein Isothiocyanate (FITC) filters were used as they have similar excitation and emission wavelengths to calcein.

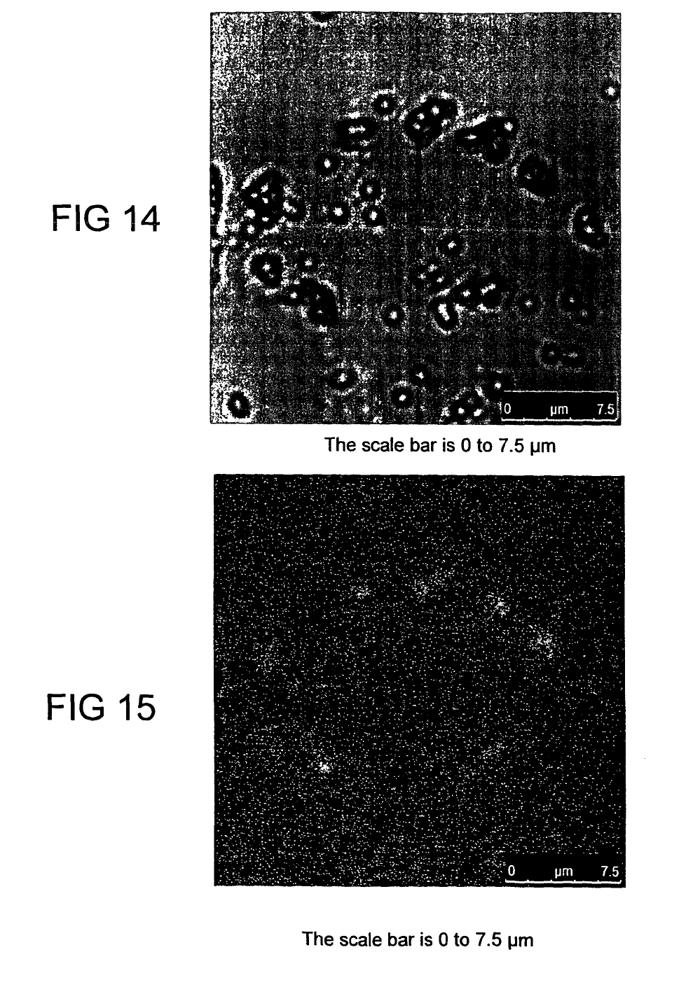

Results are shown as micrograph images in FIGS. 14 and 15. FIG. 14 shows the brightfield image in which the spores have been stained and then fixed to slide using heat; The spores are clearly visible as white dots. FIG. 15 shows a fluorescence image obtained from the same sample obtained using FITC filter settings on the same Leica microscope. The grey spots (which in the fluorescence microscope image appeared as intense green spots) have high green fluorescence which coincide with the spore structures shown in FIG. 14 when the figures are overlaid. The fluorescent spots are thus indicative of the spores. By “high” it is meant that the fluorescence is readily discernable from the background by a human eye when using a microscope.

It is noteworthy in FIGS. 14 and 15 that not all the spores stain to the same intensity. Without intending to limit the scope of the invention, it is believed that spores having higher DPA content stain more strongly than those with less DPA content. Comparison of brightfield image (in FIG. 14) with the fluorescence image shows that from the intensity of the fluorescence (in FIG. 15) it is possible to distinguish between spores that are viable in that they have a normal or high DPA content and those that are non-viable which have low or zero DPA content. The intensity level of the fluorescence signal that corresponds to a viable spore can be determined by experiment. The intensity level that corresponds to a viable spore may be different for different types of spore.

Spores were also observed using the calcein-terbium stain without using heat on the microscope slide. In these cases, the Bunsen flame was not used to fix the spores to the slide but instead the sample was allowed to dry as described above. The fluorescence photomicrograph image of this sample (using FITC filters) is shown in FIG. 17. The grey spots (which in the fluorescence microscope image appeared as intense green spots) have high green fluorescence and indicates the detection of DPA in spores. It is thus possible to sensitively observe spores without having to apply stimuli to access the DPA in the spore. That is, it is possible to penetrate the spore with the calcein-metal stain.

Spores from other bacteria could also be detected similarly. As an example for instance FIG. 21 shows the fluorescence image for clostridium difficile spores when detected microscopically using calcein-terbium stain (1.2 μM) with identical method to that described for Bacillus cereus spores (FIG. 17). Again the grey spots (which in the fluorescence microscope image appeared as intense green spots) have high green fluorescence indicating the presence of spores. Spores in the presence of vegetative or mother cells can be detected. To show this endospores were prepared from sporulating culture of Bacillus Cereus. After growth of these microorganisms on nutrient agar at 37 degrees Celsius for 24 hours, the cell mass was scrapped and suspended in water and spun at 5000 rpm for 5 minutes. The supernatant was then removed and the pellets washed two more times with water. The final pellet was resuspended in water and was used without any further attempts to remove vegetative cells. An aliquot (1 μL) of the spore suspension was placed onto a microscope slide. The slide was air dried and then flooded with Calcein-Europium stain for 1 hour. The excess stain was then washed off with deionised water, and the slide air dried. The fluorescence image was recorded on the SP2 inverted confocal microscope. Such beads as internal calibrants or internal size references can be advantageously used in accordance with the other aspects of this invention.

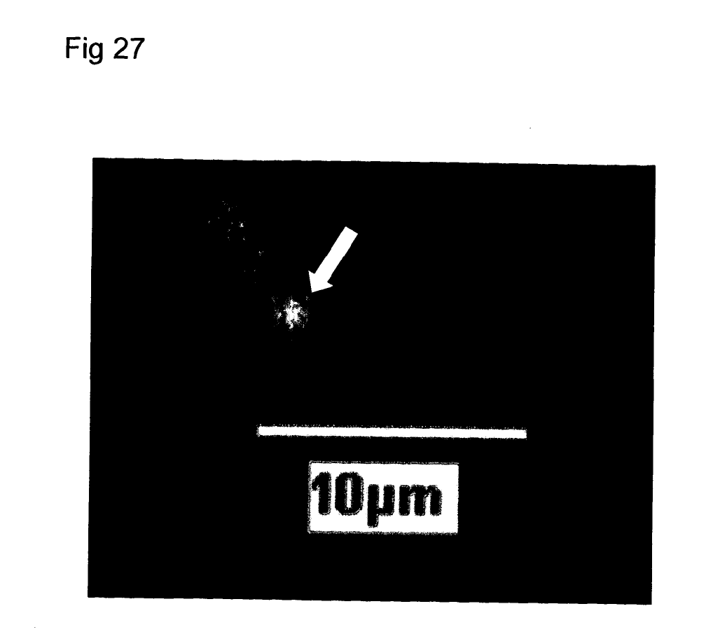

Images were recorded under fluorescence mode using FITC filters and settings. FIG. 27 shows a fluorescence image obtained from this sample. The brighter grey spot indicated by the arrow (which in the fluorescence microscope image appeared as intense green spot) has high green fluorescence and is recognised as an endospore inside a cell or sporangia which appear as rod like structure that does not stain as well as the endospore since it has no DPA.

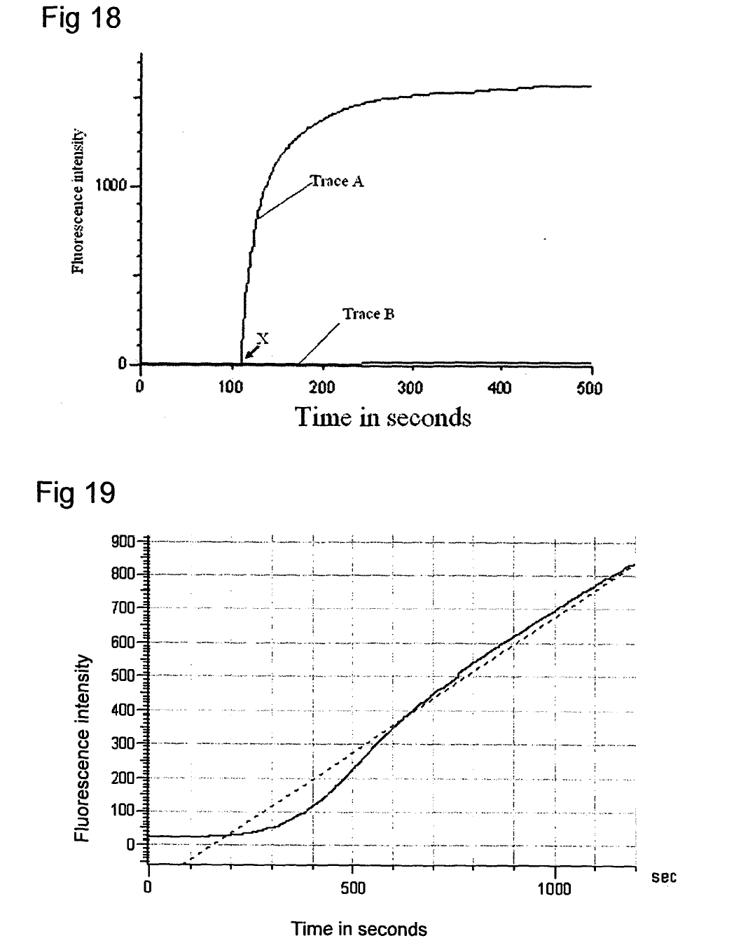

An experiment was conducted using spectrofluorometry to show that a metal-dye stain is uptaken by the spores without any treatment in solution. In this experiment Bacillus cereus spores (1×10⁷) were added to a 1.2 μM solution of calcein-terbium stain and changes in fluorescence emission intensity followed as a function of time. The excitation and emission wavelength were 485 nm and 520 nm. FIG. 19 shows a plot of fluorescence intensity against time for this experiment. An increase in signal intensity is observed with time. The data in FIG. 19 shows that calcein-metal stain was able to penetrate the spores and interact with DPA allowing detection. The spore DPA is able to displace the metal from calcein-terbium to dequench the fluorescence. As time proceeds more and more dye-metal penetrates the spores giving higher fluorescence intensity. Thus the dye-metal stain can be used to detect DPA from intact spores. A similar experiment using just calcein showed no observable change in fluorescence thus indicating that the signal is specific to the dye-metal stain detecting DPA. To substantiate this further another experiment was detected to demonstrate that the dye-metal stain is responsive to DPA but not to calcium. For this experiment a solution of calcein-terbium stain (1.2 μM) in 10 mM TES, 100 mM NaCl pH 7.4 was taken. Fluorometer was set to excitation wavelength of 485 and emission at 520 nm. Fluorescence intensity was recorded as a function of time. After 2 minutes (indicated by an arrow on FIG. 18) excess DPA (100 μM) was added and fluorescence measurements continued. The same experiment was repeated but this time adding calcium chloride (100 μM) instead of DPA was added. Results are shown in FIG. 18. It is clear that calcein-terbium stain has very low background that remains steady prior to adding DPA (Trace A FIG. 18). Upon adding DPA the fluorescence intensity increases rapidly and is established. Therefore the dye-metal has responded by re-establishing or dequenching the fluorescence and thus DPA is detected. When considering Trace B (FIG. 18) no increase in fluorescence intensity is seen above the background indicating that the dye-metal stain is relatively insensitive to calcium. Note that background signal prior to (before time point X FIG. 18) any addition of DPA or calcium chloride overlap and also being so low are in fact overlaying the x-axis.

### Example 6

In further demonstration of the invention a suspension of Bacillus cereus spores was treated with the stain used in example 5. An aliquot of this was analysed by flow cytometry showing spore specific staining with green fluorescence.

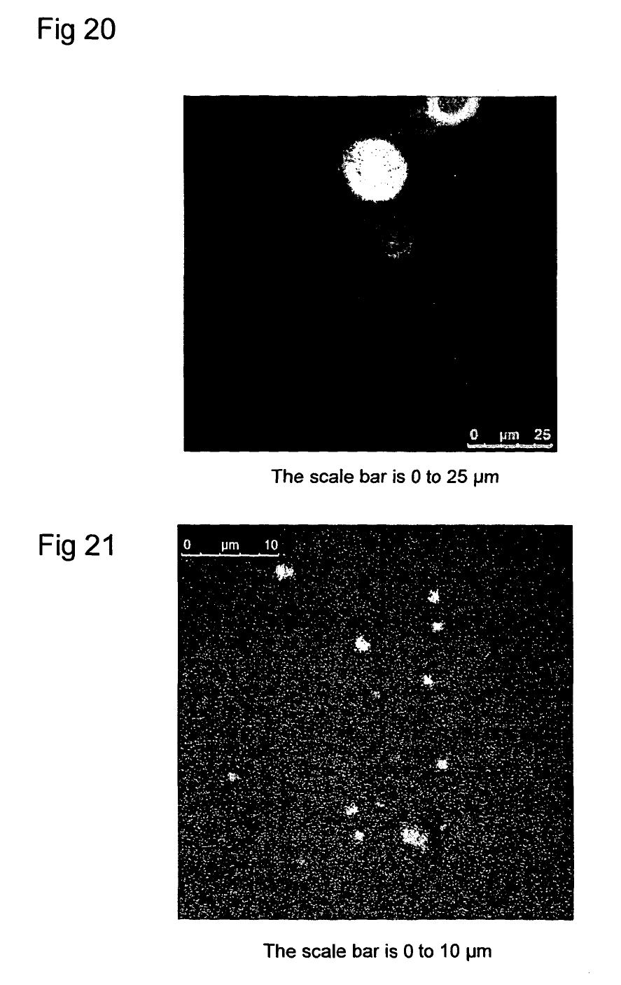

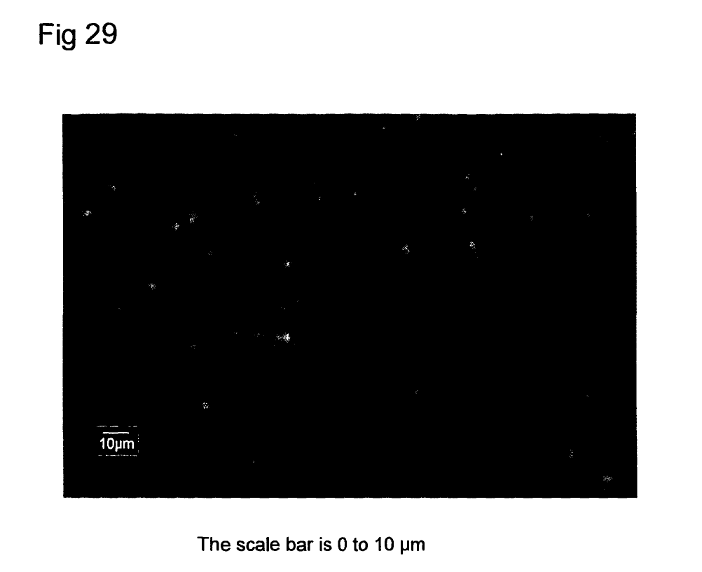

In yet another demonstration Bacillus cereus spores were captured on magnetic bead and stained. The beads were prepared by incubating an antibody (ThermoFisher Scientific) to Bacillus cereus with protein G dynal beads (obtained from Invitrogen) in phosphate buffered saline and washing the excess antibody off by capturing the beads with magnet and washing off the solution. The beads were finally suspended in 10 mM Tris pH 8 buffer at a concentration of 1×10⁸ per ml. In this experiment 5 μl of these magnetic beads (2.8 μm) were added to spores (1×10⁶) suspended in 100 μl of buffer and incubated for 40 mins followed by three wash steps using magnetic capture. The sample was then re suspended after the final wash in 20 μl of buffer and stained using calcein-terbium stain (1.2 μM) for 10 mins and imaged by fluorescence microscopy as before in example 5. FIG. 20 shows the fluorescence image obtained using FITC filter settings on the Leica SP5 upright microscope. Rings of grey (which in the fluorescence microscope image appeared as intense green rings) having high green fluorescence appeared around the magnetic beads. The results thus show that that fluorescence accumulates preferentially around the magnetic beads. It is thus possible to detect specific spores using antibodies in combination with the dye-metal in the invention. Other methods of immunocapture may also be used. Similar results may be obtained for other spores including C. difficile and using different immunocapture beads such as including latex beads. Such immunocapture beads can be advantageously used with the other aspects of this invention. Filtration and centrifugation may also be used as techniques to capture spores. For instance centrifuging at 5000 g for 5 mins and collecting the pellet concentrates the spores and filtering a suspension of spores via a 0.22 micron will concentrate the spores on the filter as they are too large to pass through. For instance FIG. 29 shows photomicrograph of Bacillus spores from centrifuge pelleted sample when stained by calcein-europium stain (as prepared in example 8) and observed as stated in example 8 using an inverted epifluorescence trinocular microscope (Fisherbrand Cat No FB69198) at 400 times magnification. The intense grey spots (which in epifluorescence photomicrograph appeared as intense green spots) have high green fluorescence and indicates the detection of DPA in spores. It is thus possible to concentrate spores and recover them for microscopic imaging using europium based calcein stain and also without having to apply stimuli to access the DPA in the spore.

Once the stain has been uptaken by the spore it may be possible to add further metal ion to the solution in order to further quench any non-specific signal outside the spore. For instance cobalt chloride solution may be used for this purpose. It is also possible to use such solution as a wash solution for washing spores to remove non-specific background. Example 2 above shows that that cobalt ions among many others can quench the dye to reduce fluorescence emission.

### Example 7

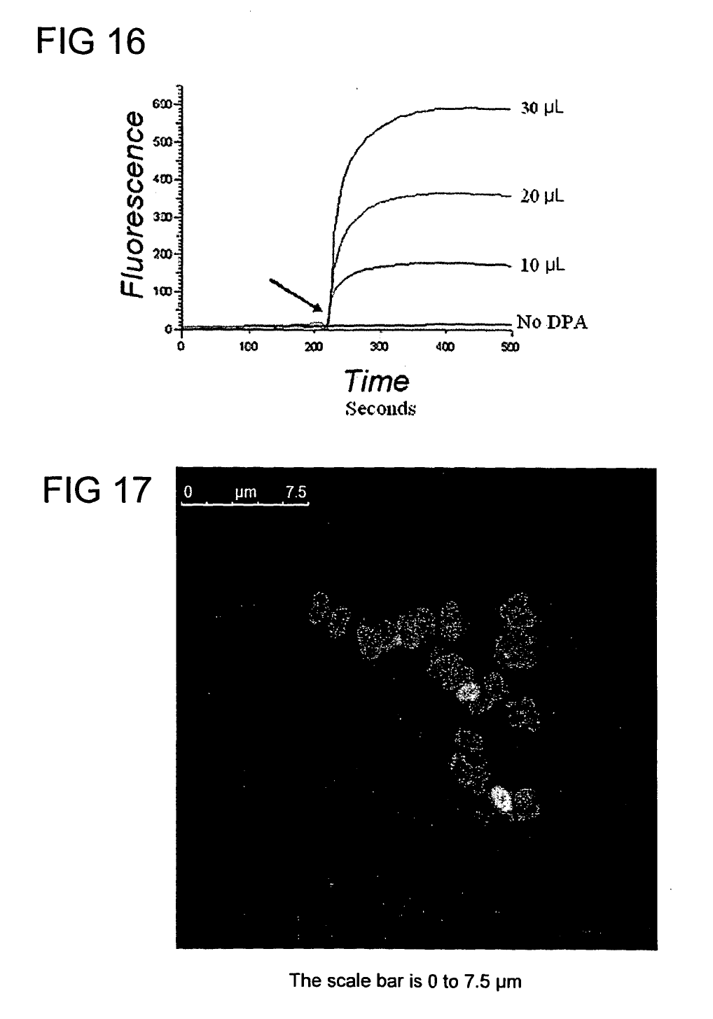

Unilamellar liposomes were used to encapsulate the calcein-terbium stain described above with reference to example 5. These were prepared by hydrating a lipid film, comprising 2:1 molar ratio of phosphatidylcholine (Lipid Products, Nutfield, UK) and cholesterol (Sigma) with 12 mM calcein dye containing 100 mM terbium chloride (Sigma) in 10 mM Tris pH 8 buffer. The hydration mixture was subjected to ten extrusion cycles through (Avestin Liposofast 100) 200-nm pore polycarbonate filters (Nucleopore) at room temperature. The non-encapsulated calcein-terbium stain was removed by gel filtration, through a Sepharose-6CLB (Pharmacia), 1.5 cm×25 cm column using iso-osmotic eluting buffer. Liposomes prepared this way remained stable and were diluted to 3 mg/ml lipid concentration. Four assays (labelled “no DPA”, 10 μL, 20 μL and 30 μL of a 2 mM stock) were conducted as follows. A 3 μL aliquot of liposomes was added to 10 mM Tris pH8 buffer and fluorescence emission recorded as a function of time using an excitation and emission wavelengths of 485 nm and 520 nm respectively. After a short period of time indicated by the arrow (FIG. 16) 10 μL of 10% sodium deoxycholate was added to rupture the liposomes. The assay was repeated but with buffer solution containing different volumes (10 μL, 20 μL and 30 μL) of 2 mM DPA solution added. While monitoring the fluorescence from the calcein, the liposomes were ruptured using detergent in order to release the stain from the liposomes. The results are shown in FIG. 16 which shows the relative fluorescence versus time in seconds for the four different assays. The arrow indicates the time in which the detergent was added to the solution. Upon rupture the stain is released and able to bind with DPA to show fluorescence increase. The results demonstrate that the increase in fluorescence is proportional to the level of DPA in the solution. Other experiments have revealed that cytolytic peptides such as melittin can also be used to release the stain from the liposomes.

In further work such liposomes were sensitized with antibodies to Bacillus Cereus spores purchased commercially (Thermo Scientific). The liposomes could be made to release DPA in the spore suspension staining B. cereus spores. This way specific spores may be detected by staining the spores that have bound the liposomes in preference to those that have not bound the liposomes. The unbound liposomes can be easily removed by centrifugation or filtration via 0.22 micron filter.

It is thus possible to target the calcein-terbium stain to spores for specific detection. For instance this can be done using receptors, ligands or antibodies to specifically target the spore surface. It is also possible for the stain to be encapsulated in particles or other matrices and deliver it to a specific spore. FIG. 16 shows that the stain can be encapsulated in 200 nm liposomes and released using a cytolytic peptide or detergent. Upon release the calcein-terbium stain is able to bind to DPA and show signal enhancement. Such systems may be used in staining specific spores. The results also demonstrate that the stain and DPA can be contained in different compartments without reaction as little or no change is seen before (<200 seconds FIG. 16) adding detergent. In this case the calcein-terbium stain is in the lumen compartment of the liposomes while DPA is free in solution. Rupture of liposomes or penetration of compartment with peptide allows the DPA to reach the stain giving signal. The situation could be compared to provide a model of spore detection, in converse sense, where the stain is free in solution and DPA is in the compartment (core) and by penetration the two meet to give signal.

Another example of the way to target the spores is to capture spores on immunomagnetic beads tethered with liposomes encapsulating the dye-metal. Alternatively one could target the stain to the spore surface or its coat protein. A number of methods are commonly available to conjugate dyes to targeting molecules including antibodies. The number of spores may be captured on such beads and beads treated with the stain to reveal the signal around the bead. Targeting approaches involving micro or nano sized particles are available in addition to direct molecular targeting, and these are included within the scope of the invention.

### Example 8

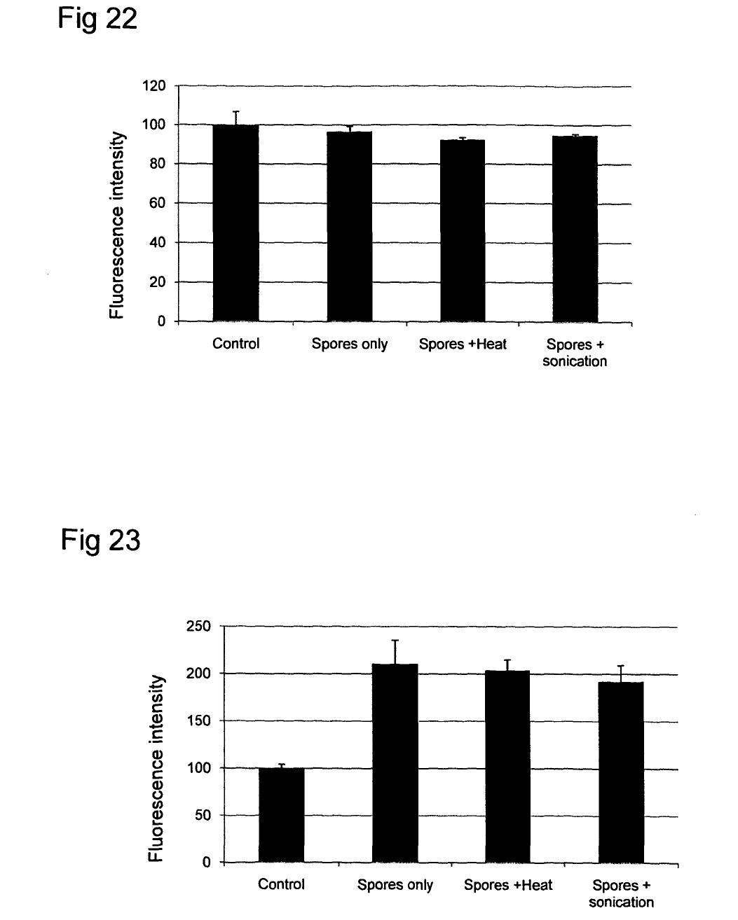

To demonstrate that dye-metal stain is able to detect whereas the dye alone without the metal is unable to detect DPA from the spores, the following experiment was carried out. For the assay bacillus cereus spore suspension equivalent to 3.5×10⁶ spores was used. Various treatments were applied for 5 minute and then solutions allowed to recover for further 5 minutes before adding to a cuvette having 2 ml of 10 mM Tris-HCL buffer pH 8 containing either 1.2 μM calcein-terbium (dye-metal stain FIG. 23) or, in the case of dye alone, 1.2 μM calcein (FIG. 22). For sonication bath (Ultrawave Ltd) was used, for heat treatment spore samples were incubated at 80 degrees centigrade for 5 mins. In all cases final readings were taken after at 60 minutes from adding spore suspension to the calcein solution. The calcein fluorescence was recorded at 520 nm with an excitation wavelength of 485 nm. For the control experiment no spores were added. It is clear from FIG. 22 that no significant change in fluorescence intensity relative to the signal in absence of spores was seen (FIG. 22) for calcein alone indicating that calcein alone is not able to detect DPA from spores in solution assay. Furthermore treating spores with ultrasound or heat did not show any detection either when calcein alone is used. In contrast there is significant increase in fluorescence intensity (FIG. 23) when calcein-terbium is used in the presence of spores compared to when spores are absent. Furthermore the strong comparable signal is achieved without applying any heat or ultrasound treatment to the spores when using calcein-terbium stain.

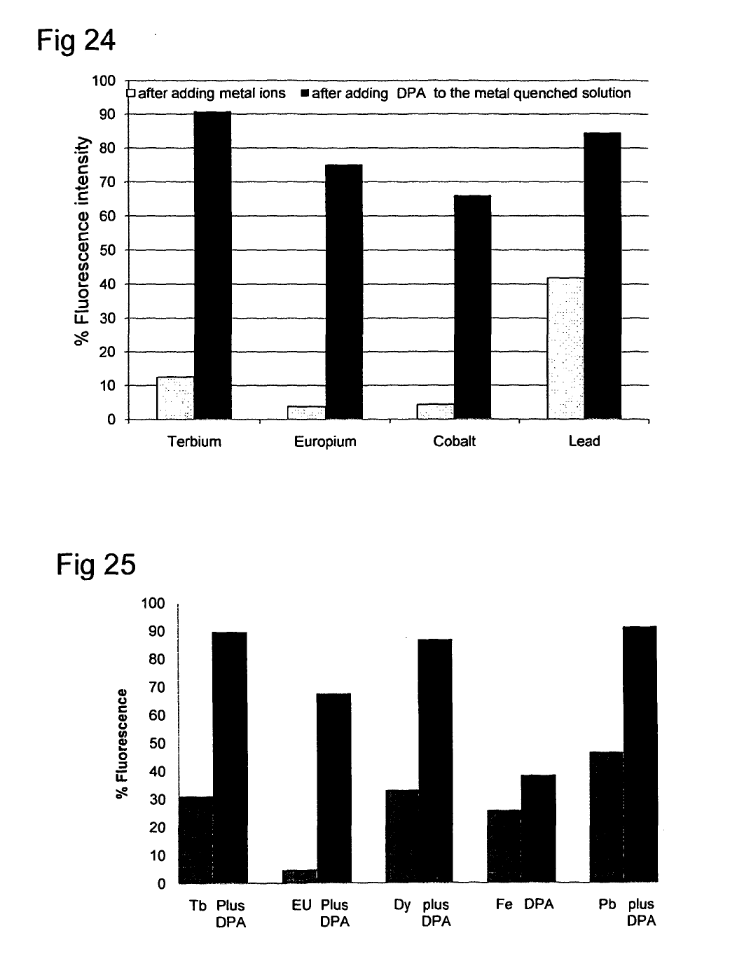

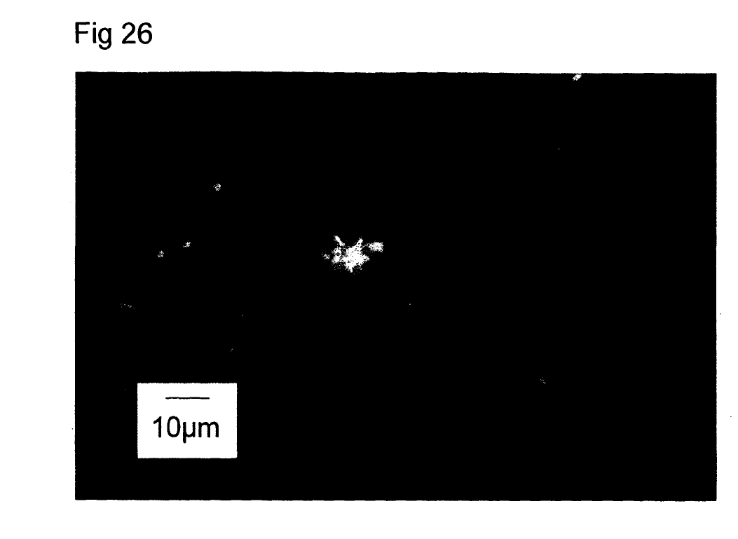

As mentioned earlier other metal ions than terbium can be used to detect DPA according to the invention. For instance FIG. 24 compares the fluorescence intensity of calcein with few other selected metals in the presence and absence of DPA. In these experiments calcein solution (1.2 μM) was taken and its fluorescence intensity recorded. Then metal ions (10 μM) were added and solution mixed and fluorescence intensity recorded again. Finally excess DPA (500 μM) was added and fluorescence measured. On the y-axis is shown % fluorescence intensity relative to calcein alone. This was calculated by dividing the observed fluorescence intensity signal by the fluorescence intensity signal of calcein alone (without the metal) and then multiplying by 100. Clearly the calcein is quenched by metal ions europium, cobalt, and lead and dequenching occurs when DPA was added to this metal quenched solutions thus showing that these metal ions could also be used to detect DPA just like the terbium. For instance a stain was prepared using europium metal rather than terbium. To make 1 ml of calcein-europium stain 0.25 ml of 1 mM Calcein dye is mixed with 0.5 ml of 1 mM europium (III) chloride and a further 0.25 ml volume of buffer is added. All solutions are in 10 mM Tris-HCL buffer pH 7.5. To demonstrate that this stain is capable of detecting spores bacillus cereus spores were stained. A sample (5 μl) of the spores was applied to a microscope slide, and allowed to air dry for 1 hour. Then 5 μl of the calcein-europium stain was added and dried for 1 hour, the excess stain was washed off with deionised water and the slides dried. Slide was then viewed on an inverted epifluorescence trinocular microscope (Fisherbrand Cat No FB69198) at 400 times magnification and using blue fluorescence excitation dichroic filter Cube (excitation spectrum 420-485 nm) and green emission filter 515 nm. FIG. 26 shows an epifluorescence photomicrograph of the stained spores. The intense grey spots (which in epifluorescence photomicrograph appeared as intense green spots) have high green fluorescence and indicates the detection of DPA in spores. It is thus possible to sensitively observe spores using europium based calcein stain and also without having to apply stimuli to access the DPA in the spore. That is, it is also possible to penetrate the spore with the calcein-europium stain. Other dyes could be similarly tested for their competitive binding to DPA and used in the invention. For instance FIG. 25 shows results for 1.5 μM Phen Green (invitrogen) solution in 10 mM Tris-HCL pH 7.5 buffer. Excitation and emission wavelengths were 507 nm and 532 nm respectively. Grey bars are after adding the metal ion (10 μM) to the Phen Green solution and the black bars are when DPA (0.5 mM) is added to this same solution containing the dye and metal ions. On the y-axis is shown % fluorescence intensity relative to Phen Green alone. This was calculated by dividing the fluorescence intensity observed by the fluorescence intensity of calcein alone (without the metal) and then multiplying by 100. Clearly fluorescence can be recovered in the presence of DPA indicating that such dyes could also be used.

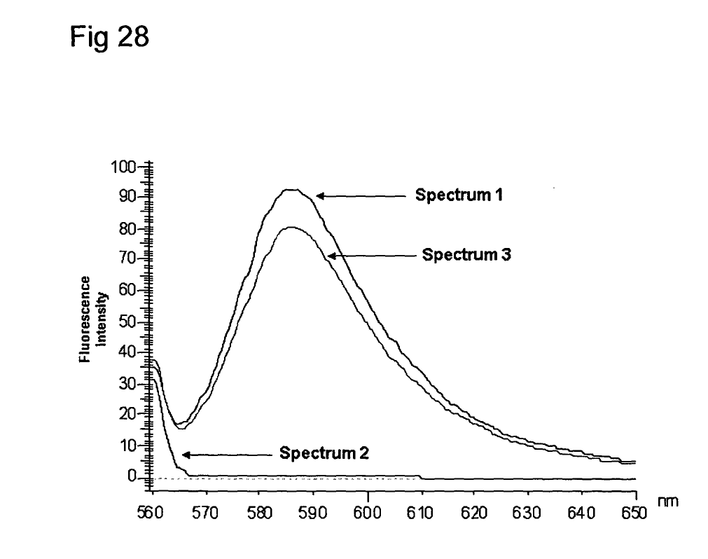

In similar experiments resorufin is another dye which can be quenched with number of metal ions metal ions and upon adding DPA to this dye metal solution fluorescence increase observed. For instance FIG. 28 shows the emission spectrum of 1.6 μM solution of resorufin (spectrum 1). When 10 μM europium is added to this same solution the resulting spectrum 2 was obtained indicating quenching of fluorescence as seen by reduction in signal intensity between 580 to 600 nm. When 50 μM DPA was added to the quenched solution the fluorescence emission recovered as shown by spectrum 3. In these cases the spectra were recorded in 10 mM Tris-HCL pH 7.4 buffer and fluorescence measurements were made on a Hitachi F-2500 fluorescence spectrophotometer with a 1 cm path length cuvette and an excitation wavelength of 550 nm. The data illustrates that resorufin-europium stain is also capable of detecting DPA.

The invention could be made to work in the reverse sense whereby a metal ion may enhance the fluorescence of the dye and DPA then acts to reduce it by binding to the metal ion. This way the signal is opposite to the signal in the previous examples of the invention in that the background will stain more than the spores. This method of negative staining can also be used to detect the spores. These negative methods, reagents and apparatus are included with the scope of the present invention.

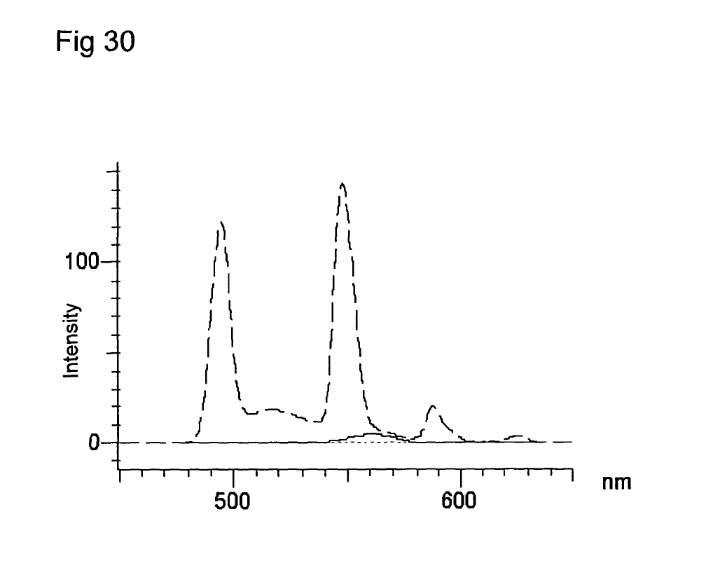

It is also possible to use the previously described methods of the invention by exciting the fluorescence of the dye by using a wavelength of light that optimally excites a lanthanide-ion chelate comprising the lanthanide ion and the DPA 1. This way signals from the lanthanide-ion chelate can be measured, signals from the dye can be measured, or fluorescence signals from both the lanthanide-ion chelate and the dye can be measured. To illustrate this, a 1.2 μM calcein-terbium stain, 1 μl aliquot was added to a cuvette contain in 1 ml of buffer (10 mM TRIS pH 7.4) fluorescence emission scanned on an Hitachi F-2500 fluorescence spectrophotometer, with setting of λ_{Ex} 277 nm and λ_{Em} 450-650 nm Emission spectrum, represented by solid line, in FIG. 30 is shown for this solution. Then an aliquot of 10 μl DPA (10 mM) was added and the scan performed again after 1 minute. The emission spectrum of this mixture is shown in FIG. 30 by dotted line. When DPA is added the increase in emission intensity at 490 nm indicates the formation of the Terbium-DPA complex while the increase at 520 nm shows the displacement of metal ion from calcein. It should be noted that the excitation wavelength used is not the most appropriate for efficient calcein excitation. However key point is that both the calcein and the terbium fluorescence can be measured individually, separately, or simultaneously in response to addition of the DPA. The use of dual fluorescence may thus provide added selectivity for detection of DPA as the calcein signal originates from displacement of the terbium with a concurrent increase in fluorescence of the terbium DPA complex. This could be used to confirm that the response seen from calcein signal is due to DPA detection aiding selectivity of the detection of DPA compared to detection of other chelates (if present).

The methods of the invention is applicable to near real-time detection of bacterial spores without interference biological materials such as bacteria, pollen, viruses, and fungal spores. The bacterial spores can be members of genera Bacillus (including B. anthracis), Clostridium (including C. Difficile, C. botulinum, C. perfringens) and Sporosarcina.

With reference to FIGS. 1 to 3, the invention extends to a spore 20 that has been penetrated by the reagent 5 comprising the second chelator (shown as the luminescent dye 3) and the metal ion 4. Preferably the spore 20 is luminescent. This can be achieved either by using the luminescent dye 3 (such as described with reference to FIGS. 1 to 32).

In an embodiment of the invention, the metal ion 4 is a luminescent metal ion such as a lanthanide (specifically samarium, europium, terbium or dysprosium), and the second chelator is selected such that when bound to the luminescent metal ion 4, the second chelator is able to penetrate the spore 20. The second chelator can be selected to have a negative charge that becomes neutralised by the positive charge of the metal ion 4. The resulting chelate, which may still be partially charged, is then able to penetrate the spore coat 24. The resulting chelate is then able to penetrate the spore coat 24. Additionally or alternatively, the resulting chelate can permeate the spore coat 24 and enter into the cortex 23. Additionally or alternatively, the resulting chelate can enter into the core 21. The second chelator can be selected such that the DPA 1 within the spore 20 displaces the luminescent metal ion 4 and forms a luminescent chelate which can be excited (typically using ultra violet light) as described in reference to FIG. 30. The luminescent chelate can be Samarium-DPA, Dysprosium-DPA, Terbium-DPA or Europium-DPA. The second chelator is preferably a luminescent dye (as described with reference to FIGS. 1 to 32), but need not be. However, as the result described with reference to FIG. 30 demonstrates, a good choice for the second chelator is a luminescent dye such as calcein because it is found that the luminescence from calcein is more intense than the luminescence from either a terbium-DPA chelate or a europium-DPA chelate when compared on a molar basis. Alternative lanthanides can also be used; although these are known to luminesce less brightly than samarium, europium, terbium or dysprosium, lanthanides such as erbium and holmium are excited at near infra red wavelengths and emit in eye safe wavelengths. This may be advantageous for avoiding using UV sources.

In the methods, reagents, apparatus, and spores of the invention, as further described with reference to FIGS. 1 to 30, the luminescent dye 3 can be selected to have a higher luminescence intensity than a terbium-DPA chelate when equal molar concentrations of the luminescent dye 3 and the terbium-DPA chelate are excited at their respective excitations wavelengths (λex) 82.

The spore 20 can be obtainable by a method described herein.

With reference to FIGS. 1 and 3, the invention extends to an endospore 20 that luminesces when excited by optical radiation 8, which endospore comprises a spore coat 24, at least one compartment 21, dipicolinic acid 1, a luminescent dye 3, and a plurality of a metal ion 4, wherein the spore coat 24 surrounds the compartment 21, the compartment 21 contains the dipicolinic acid 1, the luminescent dye 3 has a characteristic luminescence 7 when excited by the optical radiation 8, the endospore 20 being characterised in that: the metal ions 4 when bound to the luminescent dye 3 reduce the luminescence 7 of the luminescent dye 3 and increase the rate of diffusion of the luminescent dye 3 through the spore coat 24; the metal ions 4 bind to the dipicolinic acid 1 in preference to binding to the luminescent dye 3; and thus when the luminescent dye 3 is bound to the metal ion 4 and diffuses through the spore coat 24, it reacts with the dipicolinic acid 1, releasing the metal ion 4 to the dipicolinic acid 1, increases the luminescence of the dye 3, and results in an endospore 20 that luminesces when excited by the optical radiation 8.

It is to be appreciated that the embodiments of the invention described above with reference to the accompanying drawings have been given by way of example only and that modifications and additional components may be provided to enhance performance. In particular, the embodiments disclosed are without limitation to any metal ions or dye mentioned specifically. The present invention extends to the above-mentioned features taken in isolation or in any combination.

1. A method for detecting a first chemical chelator, the method comprising the steps of contacting a reagent comprising a second chelator bound to a metal ion, with a sample containing or suspected of containing the first chemical chelator, wherein at least one of the second chelator and the metal ion is luminescent, the metal ion is capable of binding to the first chemical chelator in competition with the binding to the second chelator so that contact with the reagent changes the luminescence of the sample, exciting a luminescence of at least one of the second chelator and the metal ion and detecting the luminescence emitted by the sample.

2. Method according to claim 1, wherein the reagent can penetrate into a spore.

3. Method according to claim 1 wherein the amount of first chemical chelator in the sample is determined.

4. Method according to claim 1 wherein the second chelator is a dye.

5. Method according to claim 4 in which the reagent comprises a dye-metal complex.

6. Method according to claim 1 wherein the first chemical chelator is dipicolinic acid.

7. Method according to claim 6 wherein the sample contains or is suspected of containing at least one spore comprising dipicolinic acid.

8. Method according to claim 2 wherein the spore is a viable non-germinating bacterial endospore.

9. Method according to claim 2 which the spore comprises an exosporium or spore coat, and the reagent is able to cross the exosporium or spore coat.

10. Method according to claim 2 in which the spore comprises a cortex, and the reagent is able to cross the cortex.

11. Method according to claim 7 wherein the method includes the step of releasing the dipicolinic acid from the spore into solution.

12. Method according to claim 1 wherein the second chelator is luminescent, the metal ion quenches the luminescence of the second chelator and the quenched luminescent reagent becomes dequenched when in contact with the first chemical chelator.

13. Method according to claim 12 in which the metal ion and the second chelator are selected such that the luminescence of the second chelator is quenched more strongly by the metal ion than by calcium ions on a molar basis.

14. Method according to claim 1 in which the second chelator is a fluorescent dye.

15. Method according to claim 14 in which the fluorescent dye is selected from the group comprising the following and their derivates: Calcein, resorufin, Fluorescein, rhodamine, texas red, Alexa fluor, DyLight, Cy3 and Cy5, Quantum dots, near infra red dyes, and fura dyes.

16.-65. (canceled)
